(19) United States
(12) Patent Application Publication
(10) Pub. No.: US 2026/0205242 A1
(43) Pub. Date: Jul. 16, 2026

(54) PT-RS ENHANCEMENT FOR MORE DMRS PORTS

(71) Applicant: Telefonaktiebolaget LM Ericsson (publ), Stockholm (SE)

(72) Inventors: Shiwei Gao, Nepean (CA); Andreas Nilsson, Göteborg (SE); Siva Muruganathan, Stittsville (CA)

(21) Appl. No.: 19/138,226

(22) PCT Filed: Dec. 14, 2023
(86) PCT No.: PCT/IB2023/062715

§ 371 Date: Jun. 12, 2025

Related U.S. Application Data
(60) Provisional application No. 63/432,956, filed on Dec. 15, 2022.

(51) Int. Cl. H04L 5/00

(52) U.S. Cl. CPC H04L 5/0048

(57) ABSTRACT

In one embodiment, a method performed by a User Equipment (UE) comprises, for each of one or more Resource Blocks (RBs) allocated for a configured Phase Tracking Reference Signal (PT-RS) port, determining a PT-RS subcarrier offset for the PT-RS port from a table based on a Demodulation Reference Signal (DMRS) port associated to the PT-RS port, a DMRS configuration type, and a resource element offset parameter configured for the UE. The associated DMRS port is one of a plurality of DMRS ports. Each row of the table is associated with one DMRS port and defines different PT-RS subcarrier offsets for a PT-RS port associated to that DMRS port for different resource element offset parameter values for at least one DMRS configuration type. The method further comprises, for each of the allocated RBs, transmitting/receiving a PT-RS on the PT-RS port in the RB in accordance with the determined PT-RS subcarrier offset.

### RELATED APPLICATIONS

This application claims the benefit of provisional patent application Ser. No. 63/432,956, filed Dec. 15, 2022, the disclosure of which is hereby incorporated herein by reference in its entirety.

### TECHNICAL FIELD

The present disclosure relates to a wireless communication system and, more specifically, to Phase Tracking Reference Signal (PT-RS) in a wireless communications system.

### BACKGROUND

Third Generation Partnership Project (3GPP) New Radio (NR) uses Cyclic Prefix Orthogonal Frequency Division Multiplexing (CP-OFDM) in both downlink (DL) (i.e., from a network node, gNB, or base station, to a user equipment or UE) and uplink (UL) (i.e., from UE to gNB). Discrete Fourier Transform (DFT) spread Orthogonal Frequency Division Multiplexing (OFDM) is also supported in the uplink. In the time domain, NR downlink and uplink are organized into equally sized subframes of 1 millisecond (ms) each. A subframe is further divided into multiple slots of equal duration. The slot length depends on subcarrier spacing. For subcarrier spacing of Δf=15 kilohertz (kHz), there is only one slot per subframe, and each slot consists of 14 OFDM symbols.

Data scheduling in NR is typically in slot basis, an example is shown in FIG. 1A with a 14-symbol slot, where the first two symbols contain Physical Downlink Control Channel (PDCCH) and the rest of the symbols contain physical shared data channel, either Physical Downlink Shared Channel (PDSCH) or Physical Uplink Shared Channel (PUSCH).

Different subcarrier spacing (SCS) values are supported in NR. The supported SCS values (also referred to as different numerologies) are given by Δf=(15×2\hat{ }μ) kHz where μ∈{0,1,2,3,4}. Δf=15 kHz is the basic subcarrier spacing. The slot duration for a given subcarrier spacing is 1/2\hat{ }μ ms.

In the frequency domain, a system bandwidth is divided into Resource Blocks (RBs), each corresponds to 12 contiguous subcarriers. The RBs are numbered starting with 0 from one end of the system bandwidth. The basic NR physical time-frequency resource grid is illustrated in FIG. 1B, where only one RB within a 14-symbol slot is shown. One OFDM subcarrier during one OFDM symbol interval forms one Resource Element (RE).

Downlink transmissions to a User Equipment (UE) can be dynamically scheduled by sending Downlink Control Information (DCI) with a DL DCI format on PDCCH. The DCI contains scheduling information such as time and frequency resource, modulation and coding scheme, etc. The user data are carried on PDSCH. The UE first detects and decodes PDCCH and if the decoding is successfully, it then decodes the corresponding PDSCH according to the scheduling information in the DCI.

Similarly, uplink data transmission can be dynamically scheduled using a UL DCI format on PDCCH. A UE first decodes uplink grants in the DCI and then transmits data over PUSCH according to the control information contained in the uplink grant such as modulation order, coding rate, uplink resource allocation, etc.

### NR PT-RS

In NR, Phase Tracking Reference Signal (PT-RS or PTRS) can be configured for downlink and uplink transmissions in order for the receiver to correct phase noise related errors. The PT-RS configuration is UE-specific, and the PT-RS is associated with one of the Demodulation Reference Signal (DMRS) ports used for the PDSCH or PUSCH transmission, meaning that DMRS and its associated PT-RS are transmitted using the same precoder and meaning that the modulated symbol used for the PT-RS is taken from the DMRS, whatever DMRS sequence is configured. This means that there is no specific configuration of the PT-RS sequence as it borrows from the DMRS.

In DL, if a UE is scheduled with one codeword, the PT-RS antenna port is associated with the lowest indexed DMRS antenna port among the DMRS antenna ports assigned for the PDSCH. If a UE is scheduled with two codewords, the PT-RS antenna port is associated with the lowest indexed DMRS antenna port among the DMRS antenna ports assigned for the codeword with the higher MCS. If the MCS indices of the two codewords are the same, the PT-RS antenna port is associated with the lowest indexed DMRS antenna port assigned for codeword 0.

In UL, for PUSCH scheduled by DCI format 0_0 or by activation DCI format 0_0, the UL PT-RS port is associated to DMRS port 0. For PUSCH scheduled by DCI format 0_1 and DCI format 0_2, the PT-RS port to DMRS port association is dynamically indicated in DCI and is described in clause 6.2.2 in 3GPP Technical Specification (TS) 38.214 (see, e.g., v17.3.0).

The presence of PT-RS is indicated by Radio Resource Control (RRC) signaling for UL and DL independently. The uplink and downlink PTRS configurations in 3GPP TS 38.331 v17.2.0 are shown in FIG. 1C.

At most two PT-RS ports per user (to support multi-panel transmission in UL and multi-Transmission and Reception Point (TRP) transmission in DL) are configured. This is configured by maxNrofPorts. There can be at most six orthogonal PT-RS ports in total for Multi-User Multiple Input Multiple Output (MU-MIMO) for Type2 DMRS and four orthogonal PT-RS ports in total for Type1 DMRS. PT-RS port is precoded over antenna ports using the same precoder of the associated DMRS port. PT-RS are not mapped to resource elements used for DMRS, Synchronization Signal Block (SSB), Channel State Information Reference Signal (CSI-RS, and etc.

The supported time and frequency densities for PT-RS in case of CP-OFDM include:
Time densities: 1, ½, and ¼ (i.e., one PT-RS symbol every symbol, every 2nd symbol, and every 4th OFDM symbol, respectively)·
Freq. densities: ½ and ¼ (i.e., one PTRS subcarrier every 2nd Physical Resource Block (PRB) and every 4th PRB, respectively)

Time and frequency density are associated with DCI parameters, such as Modulation and Coding Scheme (MCS) and scheduled bandwidth (BW), and are specified by clause 5.1.6.3 in 3GPP TS 38.214 v17.2.0 for DL and clause 6.2.3 in 3GPP TS 38.214 v17.2.0 for UL.

PT-RS is confined in the scheduling RBs. The RBs containing PT-RS are derived as follows. For DL/UL unicast transmissions, RB-level offset is implicitly derived from the UE's Radio Network Temporary Identifier (RNTI) and frequency density. PT-RS is mapped on one DMRS subcarrier of the associated DMRS port in each allocated RB. Also, the subcarrier used for a PT-RS port must be one of the subcarriers also used for the DM-RS port associated with the PT-RS port. PTRS sub-carrier k in the scheduled PDSCH or PUSCH RBs is determined as

$$k = {k}_{ref}^{RE} + ( {iK}_{PT - RS} + {k}_{ref}^{RB} ) {N}_{sc}^{RB}$$

where:
i=0,1,2, . . .

$${k}_{ref}^{RE}$$

is the sub-carrier offset and is given in Table 7.4.1.2.2-1 of 3GPP TS 38.211 v17.2.0 for DL and in Table 6.4.1.2.2.1-1 of 3GPP TS 38.211 v17.2.0 for UL. The tables are reproduced below as Tables 1 and 2, where resourceElementOffset is a parameter configured by RRC. If resourceElementOffset is not configured, the column corresponding to ‘offset00’ shall be used.
K_{PT-RS} is the frequency density of PT-RS and K_{PT,RS}∈{2,4}

$${k}_{ref}^{RB}$$

is the RB offset for the PT-RS and is given by

$${k}_{ref}^{RB} = \{ \begin{matrix}{n}_{RNTI} mod {K}_{PT - RS} & if {N}_{RB} mod {K}_{PT - RS} = 0 \\ {n}_{RNTI} mod ( {N}_{RB} mod {K}_{PT - RS} ) & otherwise\end{matrix}$$

$${N}_{sc}^{RB}$$

is the number of subcarriers per RB
N_{RB} is the number of scheduled RBs
n_{RNTI} is the RNTI associated with the DCI scheduling the transmission.
   Within each RB allocated for PT-RS, the subcarrier for PT-RS, also referred to as resource element offset, is determined by both the index of the associated DMRS port and an RRC configured parameter resourceElementOffset.

Note that in the DL, the DMRS antenna ports (the same for PDSCH transmission) start from port index 1000, while in the UL, the DMRS antenna ports (the same for PUSCH transmission) start from 0. In NR, the same DMRS design is used for both PDSCH in DL and PUSCH in UL. For ease of discussion, a relative DMRS numbering, i.e., DMRS port starting with port 0 may be used in the following discussion for both DL and UL. In that case, it is understood that for DL, DMRS port k actually means DMRS port 1000+k in the DL.

TABLE 1
$Reproduction of Table 7.4 \text{.1} \text{.2} \text{.2} \text{.1} - 1 ( The parameter {k}_{ref}^{RE} ( DL ) ) of TS 38.211 v 17.2 \text{.0}$

| | ${k}_{ref}^{RE}$ | | | | | | | |
|---|---|---|---|---|---|---|---|---|
| DM-RS | DM-RS Configuration type 1 | | | | DM-RS Configuration type 2 | | | |
| antenna port | resourceElementOffset | | | | resourceElementOffset | | | |
| p | offset00 | offset01 | offset10 | offset11 | offset00 | offset01 | offset10 | offset11 |
| 1000 | 0 | 2 | 6 | 8 | 0 | 1 | 6 | 7 |
| 1001 | 2 | 4 | 8 | 10 | 1 | 6 | 7 | 0 |
| 1002 | 1 | 3 | 7 | 9 | 2 | 3 | 8 | 9 |
| 1003 | 3 | 5 | 9 | 11 | 3 | 8 | 9 | 2 |
| 1004 | — | — | — | — | 4 | 5 | 10 | 11 |
| 1005 | — | — | — | — | 5 | 10 | 11 | 4 |

TABLE 2
$Reproduction of Table 6.4 \text{.1} \text{.2} \text{.2} \text{.1} - 1 ( The parameter {k}_{ref}^{RE} ( UL ) ) of TS 38.211 v 17.2 \text{.0}$

| | ${k}_{ref}^{RE}$ | | | | | | | |
|---|---|---|---|---|---|---|---|---|
| DM-RS | DM-RS Configuration type 1 | | | | DM-RS Configuration type 2 | | | |
| antenna port | resourceElementOffset | | | | resourceElementOffset | | | |
| \tilde{p} | offset00 | offset01 | offset10 | offset11 | offset00 | offset01 | offset10 | offset11 |
| 0 | 0 | 2 | 6 | 8 | 0 | 1 | 6 | 7 |
| 1 | 2 | 4 | 8 | 10 | 1 | 6 | 7 | 0 |
| 2 | 1 | 3 | 7 | 9 | 2 | 3 | 8 | 9 |
| 3 | 3 | 5 | 9 | 11 | 3 | 8 | 9 | 2 |
| 4 | — | — | — | — | 4 | 5 | 10 | 11 |
| 5 | — | — | — | — | 5 | 10 | 11 | 4 |

For PT-RS time domain mapping, the mapping starts at the first symbol containing PDSCH/PUSCH in a slot. Then, it is mapped to every L symbols (according to the time density 1/L). PT-RS is not transmitted in OFDM symbols that contain PDSCH/PUSCH DMRS. PTRS mapping is restarted at each DMRS symbol and then mapped relative to this symbol. In case of two adjacent DMRS symbols, the mapping is restarted using the second DMRS symbol as a reference.

An example of PTRS REs in a PTRS RB is shown in FIG. 1D for time domain density ½, where the PTRS port is associated with type 1 DMRS port 1 and the RRC parameter resourceElementOffset is configured as ‘offset10’ with a single symbol DMRS in the RB at the left side of FIG. 1D and a double symbol DMRS in the RB at the right side of FIG. 1D.

Another example is shown in FIG. 1E, where the PTRS port is associated with a single symbol type 1 DMRS port 1 (shown on the left side of FIG. 1E) and a single symbol type 2 DMRS port 1 (shown on the right side of FIG. 1E), and again both with the RRC parameter resourceElementOffset configured as ‘offset10’ but with a PTRS time density of L=1.

For CP-OFDM, in each subcarrier allocated for PT-RS, the DMRS symbol in that subcarrier and the first front-loaded DMRS OFDM symbol before applying FD-OCC is used also for the PT-RS.

As discussed above, two types of DMRS for PDSCH and PUSCH are supported in NR, i.e., type 1 and type 2. The maximum number of DMRS ports for type 1 DMRS is 4 for single symbol DMRS and 8 for double symbol DMRS. For type 2 DMRS, the maximum number of DMRS ports is 6 for single symbol DMRS and 12 for double symbol DMRS.

DMRS ports are organized in Code Division Multiplexing (CDM) groups. For type 1 DMRS, there are two CDM groups, groups 0 and 1. CDM group 0 is defined on six even numbered sub-carriers while CDM group 1 is defined on six odd numbered sub-carriers, in each RB in an OFDM symbol. For type 2 DMRS, there are three CDM groups, each comprising two pairs of REs in each RB. An example is shown in FIG. 1E.

Each CDM group comprises two DMRS ports for single symbol DMRS, and the two DMRS ports are multiplexed using frequency domain orthogonal cover codes with length of 2 (FD-OCC2). The number of DMRS ports are doubled when double symbol DMRS is configured, where time domain (TD) OCC of length 2 (TD-OCC2) is used across two OFDM symbols in addition to FD-OCC2. The details are described in clause 6.4.1.1 and clause 7.4.1.1 in 3GPP TS 38.211. The relation of DMRS ports and CDM groups for PUSCH is shown in FIG. 2A for type 1 DMRS and FIG. 2B for type 2 DMRS. The same is applicable to PDSCH DMRS by simply replacing port p with p=1000+p.

An important aspect is that PT-RS is not scheduled when using TD-OCC for the DMRS. Therefore, PT-RS will never be present when using DMRS ports 1004-1007 for DMRS type 1 and ports 1006-1011 for DMRS type 2 for PDSCH. The same is also applicable to DMRS for PUSCH.

### PT-RS Power Allocation

The PT-RS transmit power may be boosted when the PDSCH contains more than one spatial layer. In other words, the ratio of PT-RS energy per resource element (EPRE) to PDSCH EPRE per layer (PPTRS) can be greater than 0 decibels (dB). This is because, for PT-RS, only a single layer is transmitted while PDSCH can have multiple layers. For the same total EPRE, per layer EPRE for PT-RS can be larger than for PDSCH when the PDSCH has more than one layer.

When the UE is scheduled with one or two PT-RS ports associated with the PDSCH and if the UE is configured with the higher layer parameter epre-Ratio, the ratio of PT-RS EPRE to PDSCH EPRE per layer per RE for each PT-RS port (ρ_{PTRS}) is given by Table 4.1-2 in 3GPP TS 38.214 v17.2.0 (reproduced below as Table 3) according to the epre-Ratio. Otherwise, if the UE is not configured with the higher layer parameter epre-Ratio, the UE shall assume epre-Ratio is set to state ‘0’ in Table 4.1-2.

TABLE 3
Reproduction of Table 4.1-2 (PT-RS EPRE to PDSCH
EPRE per layer per RE (ρ_{PTRS}) of TS38.214

| | |
|---|---|
| | The number of PDSCH layers with |
| epre- | DM-RS associated to the PT-RS port |

| Ratio | 1 | 2 | 3 | 4 | 5 | 6 |
|---|---|---|---|---|---|---|
| 0 | 0 | 3 | 4.77 | 6 | 7 | 7.78 |
| 1 | 0 | 0 | 0 | 0 | 0 | 0 |

| | |
|---|---|
| 2 | reserved |
| 3 | reserved |

Similarly, when the UE is scheduled with Qₚ={1,2} PT-RS port(s) in uplink and the number of scheduled layers is

$${n}_{layer}^{PUSCH} ,$$

the PUSCH to PT-RS power ratio per layer per RE

$${ρ}_{PTRS}^{PUSCH}$$

is given by

$${ρ}_{PTRS}^{PUSCH} = - {α}_{PTRS}^{PUSCH} [ dB ] , where {α}_{PTRS}^{PUSCH}$$

is shown in Table 6.2.3.1-3 of 3GPP TS 38.214 v17.2.0 (reproduced herein as Table 4) if the higher layer parameter ptrs-Power is configured.

If the higher layer parameter ptrs-Power is not configured, the UE shall assume ptrs-Power in PTRS-UplinkConfig is set to state “00” in Table 6.2.3.1-3 of 3GPP TS 38.314.

TABLE 4
Reproduction of Table 6.2.3.1-3 (Factor related to PUSCH to PT-RS power ratio per
$layer per RE {α}_{PTRS}^{PUSCH} ) of TS 38.214$

| | | $The number of PUSCH layers ( {n}_{layer}^{PUSCH} )$ | | | | | | |
|---|---|---|---|---|---|---|---|---|
| | | 2 | | 3 | | | | |
| | | | Partial | | Partial | 4 | | |
| | | | and non- | | and non- | | | Non- |
| UL- | | | coherent | | coherent | | | coherent |
| PTRS- | 1 | | and non- | | and non- | | | and non- |
| power/ | All | Full | codebook | Full | codebook | Full | Partial | codebook |
| ${α}_{PTRS}^{PUSCH}$ | cases | coherent | based | coherent | based | coherent | coherent | based |
| 00 | 0 | 3 | 3Qₚ-3 | 4.77 | 3Qₚ-3 | 6 | 3Qₚ | 3Qₚ-3 |
| 01 | 0 | 3 | 3 | 4.77 | 4.77 | 6 | 6 | 6 |

| | |
|---|---|
| 10 | Reserved |
| 11 | Reserved |

In NR Rel-18, the number of DMRS ports per CDM group will be doubled for both type 1 and type 2 DMRS by introducing length 4 frequency domain (FD) OCC codes in each CDM group as shown in FIG. 2C for type 1 DMRS and in FIG. 2D for type 2 DMRS. The same is applicable to PDSCH DMRS by simply replacing port p with p=1000+p.

### SUMMARY

Systems and methods are disclosed that relate to Phase Tracking Reference Signal (PT-RS) for an increased number of Demodulation Reference Signal (DMRS) ports. In one embodiment, a method performed by a User Equipment (UE) in a wireless communication system comprises, for each resource block (RB) of one or more RBs allocated for a PT-RS port configured for the UE, determining a PT-RS subcarrier offset for the PT-RS port from a table based on a DMRS port associated to the PT-RS port, a DMRS configuration type, and a resource element offset parameter configured for the UE. The DMRS port associated to the PT-RS port is one of a plurality of DMRS ports, wherein eight of the plurality of DMRS ports are associated to a first DMRS configuration type and twelve of the plurality of DMRS ports are associated to a second DMRS configuration type. Each row of the table is associated with one of the plurality of DMRS ports and defines different PT-RS subcarrier offsets for a PT-RS port associated to the one of the plurality of DMRS ports for different resource element offset parameter values for at least one of the first DMRS configuration type and the second DMRS configuration type. The method further comprises, for each RB of the one or more RBs allocated for the PT-RS port configured for the UE, transmitting or receiving a PT-RS on the PT-RS port in the RB in accordance with the determined PT-RS subcarrier offset. In this manner, phase tracking with PT-RS for Physical Downlink Shared Channel (PDSCH) or Physical Uplink Shared Channel (PUSCH) with up to eight layers is enabled by allocating proper sub-carrier offsets.

In one embodiment, the table is an uplink table associated to PUSCH transmissions, and the one or more RBs are a subset of N_{RB}≥1 RBs scheduled for PUSCH. In one embodiment, the plurality of DMRS ports comprise DMRS ports 0 through 17, and the uplink table comprises:
a row associated to a DMRS port 8 that defines:
   a PT-RS subcarrier offset of 4 for a resource offset parameter value of ‘00’ for the first DMRS configuration type;
   a PT-RS subcarrier offset of 6 for a resource offset parameter value of ‘01’ for the first DMRS configuration type;
   a PT-RS subcarrier offset of 10 for a resource offset parameter value of ‘10’ for the first DMRS configuration type; and
   a PT-RS subcarrier offset of 0 for a resource offset parameter value of ‘11’ for the first DMRS configuration type;
a row associated to a DMRS port 9 that defines:
   a PT-RS subcarrier offset of 6 for the resource offset parameter value of ‘00’ for the first DMRS configuration type;
   a PT-RS subcarrier offset of 8 for the resource offset parameter value of ‘01’ for the first DMRS configuration type;
   a PT-RS subcarrier offset of 0 for the resource offset parameter value of ‘10’ for the first DMRS configuration type; and
   a PT-RS subcarrier offset of 2 for the resource offset parameter value of ‘11’ for the first DMRS configuration type;
a row associated to a DMRS port 10 that defines:
   a PT-RS subcarrier offset of 5 for the resource offset parameter value of ‘00’ for the first DMRS configuration type;
   a PT-RS subcarrier offset of 7 for the resource offset parameter value of ‘01’ for the first DMRS configuration type;
   a PT-RS subcarrier offset of 11 for the resource offset parameter value of ‘10’ for the first DMRS configuration type; and
   a PT-RS subcarrier offset of 1 for the resource offset parameter value of ‘11’ for
a row associated to a DMRS port 11 that defines:
   a PT-RS subcarrier offset of 7 for the resource offset parameter value of ‘00’ for
   a PT-RS subcarrier offset of 9 for the resource offset parameter value of ‘01’ for the first DMRS configuration type;
   a PT-RS subcarrier offset of 1 for the resource offset parameter value of ‘10’ for the first DMRS configuration type; and
   a PT-RS subcarrier offset of 3 for the resource offset parameter value of ‘11’ for the first DMRS configuration type;
a row associated to a DMRS port 12 that defines:
   a PT-RS subcarrier offset of 6 for the resource offset parameter value of ‘00’ for the second DMRS configuration type;
   a PT-RS subcarrier offset of 7 for the resource offset parameter value of ‘01’ for the second DMRS configuration type;
   a PT-RS subcarrier offset of 0 for the resource offset parameter value of ‘10’ for the second DMRS configuration type; and
   a PT-RS subcarrier offset of 1 for the resource offset parameter value of ‘11’ for the second DMRS configuration type;
a row associated to a DMRS port 13 that defines:
   a PT-RS subcarrier offset of 7 for the resource offset parameter value of ‘00’ for the second DMRS configuration type;
   a PT-RS subcarrier offset of 0 for the resource offset parameter value of ‘01’ for the second DMRS configuration type;
   a PT-RS subcarrier offset of 1 for the resource offset parameter value of ‘10’ for the second DMRS configuration type; and
   a PT-RS subcarrier offset of 6 for the resource offset parameter value of ‘11’ for the second DMRS configuration type;
a row associated to a DMRS port 14 that defines:
   a PT-RS subcarrier offset of 8 for the resource offset parameter value of ‘00’ for the second DMRS configuration type;
   a PT-RS subcarrier offset of 9 for the resource offset parameter value of ‘01’ for the second DMRS configuration type;
   a PT-RS subcarrier offset of 2 for the resource offset parameter value of ‘10’ for the second DMRS configuration type; and
   a PT-RS subcarrier offset of 3 for the resource offset parameter value of ‘11’ for the second DMRS configuration type;
a row associated to a DMRS port 15 that defines:
   a PT-RS subcarrier offset of 9 for the resource offset parameter value of ‘00’ for the second DMRS configuration type;
   a PT-RS subcarrier offset of 2 for the resource offset parameter value of ‘01’ for the second DMRS configuration type;
   a PT-RS subcarrier offset of 3 for the resource offset parameter value of ‘10’ for the second DMRS configuration type; and
   a PT-RS subcarrier offset of 8 for the resource offset parameter value of ‘11’ for the second DMRS configuration type;
a row associated to a DMRS port 16 that defines:
   a PT-RS subcarrier offset of 10 for the resource offset parameter value of ‘00’ for the second DMRS configuration type;
   a PT-RS subcarrier offset of 11 for the resource offset parameter value of ‘01’ for the second DMRS configuration type;
   a PT-RS subcarrier offset of 4 for the resource offset parameter value of ‘10’ for the second DMRS configuration type; and
   a PT-RS subcarrier offset of 5 for the resource offset parameter value of ‘11’ for the second DMRS configuration type; and
a row associated to a DMRS port 17 that defines:
   a PT-RS subcarrier offset of 11 for the resource offset parameter value of ‘00’ for the second DMRS configuration type;
   a PT-RS subcarrier offset of 4 for the resource offset parameter value of ‘01’ for the second DMRS configuration type;
   a PT-RS subcarrier offset of 5 for the resource offset parameter value of ‘10’ for the second DMRS configuration type; and
   a PT-RS subcarrier offset of 10 for the resource offset parameter value of ‘11’ for the second DMRS configuration type.

In one embodiment, the uplink table further comprises:
a row associated to a DMRS port 0 that defines:
   a PT-RS subcarrier offset of 0 for the resource offset parameter value of ‘00’ for the first DMRS configuration type;
   a PT-RS subcarrier offset of 2 for the resource offset parameter value of ‘01’ for the first DMRS configuration type;
   a PT-RS subcarrier offset of 6 for the resource offset parameter value of ‘10’ for the first DMRS configuration type;
   a PT-RS subcarrier offset of 8 for the resource offset parameter value of ‘11’ for the first DMRS configuration type;
   a PT-RS subcarrier offset of 0 for the resource offset parameter value of ‘00’ for the second DMRS configuration type;
   a PT-RS subcarrier offset of 1 for the resource offset parameter value of ‘01’ for the second DMRS configuration type;
   a PT-RS subcarrier offset of 6 for the resource offset parameter value of ‘10’ for the second DMRS configuration type; and
   a PT-RS subcarrier offset of 7 for the resource offset parameter value of ‘11’ for the second DMRS configuration type;
a row associated to a DMRS port 1 that defines:
   a PT-RS subcarrier offset of 2 for the resource offset parameter value of ‘00’ for the first DMRS configuration type;
   a PT-RS subcarrier offset of 4 for the resource offset parameter value of ‘01’ for the first DMRS configuration type;
   a PT-RS subcarrier offset of 8 for the resource offset parameter value of ‘10’ for the first DMRS configuration type;
   a PT-RS subcarrier offset of 10 for the resource offset parameter value of ‘11’ for the first DMRS configuration type;
   a PT-RS subcarrier offset of 1 for the resource offset parameter value of ‘00’ for the second DMRS configuration type;
   a PT-RS subcarrier offset of 6 for the resource offset parameter value of ‘01’ for the second DMRS configuration type;
   a PT-RS subcarrier offset of 7 for the resource offset parameter value of ‘10’ for the second DMRS configuration type; and
   a PT-RS subcarrier offset of 0 for the resource offset parameter value of ‘11’ for the second DMRS configuration type;
a row associated to a DMRS port 2 that defines:
   a PT-RS subcarrier offset of 1 for the resource offset parameter value of ‘00’ for the first DMRS configuration type;
   a PT-RS subcarrier offset of 3 for the resource offset parameter value of ‘01’ for the first DMRS configuration type;
   a PT-RS subcarrier offset of 7 for the resource offset parameter value of ‘10’ for the first DMRS configuration type;
   a PT-RS subcarrier offset of 9 for the resource offset parameter value of ‘11’ for the first DMRS configuration type;
   a PT-RS subcarrier offset of 2 for the resource offset parameter value of ‘00’ for the second DMRS configuration type;
   a PT-RS subcarrier offset of 3 for the resource offset parameter value of ‘01’ for the second DMRS configuration type;
   a PT-RS subcarrier offset of 8 for the resource offset parameter value of ‘10’ for the second DMRS configuration type; and
   a PT-RS subcarrier offset of 9 for the resource offset parameter value of ‘11’ for the second DMRS configuration type;
a row associated to a DMRS port 3 that defines:
   a PT-RS subcarrier offset of 3 for the resource offset parameter value of ‘00’ for the first DMRS configuration type;
   a PT-RS subcarrier offset of 5 for the resource offset parameter value of ‘01’ for the first DMRS configuration type;
   a PT-RS subcarrier offset of 9 for the resource offset parameter value of ‘10’ for the first DMRS configuration type;
   a PT-RS subcarrier offset of 11 for the resource offset parameter value of ‘11’ for the first DMRS configuration type;
   a PT-RS subcarrier offset of 3 for the resource offset parameter value of ‘00’ for the second DMRS configuration type;
   a PT-RS subcarrier offset of 8 for the resource offset parameter value of ‘01’ for the second DMRS configuration type;
   a PT-RS subcarrier offset of 9 for the resource offset parameter value of ‘10’ for the second DMRS configuration type; and
   a PT-RS subcarrier offset of 2 for the resource offset parameter value of ‘11’ for the second DMRS configuration type;
a row associated to a DMRS port 4 that defines:
   a PT-RS subcarrier offset of 4 for the resource offset parameter value of ‘00’ for the second DMRS configuration type;
   a PT-RS subcarrier offset of 5 for the resource offset parameter value of ‘01’ for the second DMRS configuration type;
   a PT-RS subcarrier offset of 10 for the resource offset parameter value of ‘10’ for the second DMRS configuration type; and
   a PT-RS subcarrier offset of 11 for the resource offset parameter value of ‘11’ for the second DMRS configuration type; and
a row associated to a DMRS port 5 that defines:
   a PT-RS subcarrier offset of 5 for the resource offset parameter value of ‘00’ for the second DMRS configuration type;
   a PT-RS subcarrier offset of 10 for the resource offset parameter value of ‘01’ for the second DMRS configuration type;
   a PT-RS subcarrier offset of 11 for the resource offset parameter value of ‘10’ for the second DMRS configuration type; and
   a PT-RS subcarrier offset of 4 for the resource offset parameter value of ‘11’ for the second DMRS configuration type.

In one embodiment, the table is a downlink table associated to PDSCH transmissions, and wherein the one or more RBs are a subset of N_{RB}≥1 RBs scheduled for PDSCH. In one embodiment, the plurality of DMRS ports comprise DMRS ports 0 through 17, and the downlink table comprises:
a row associated to a DMRS port 1008 that defines:
   a PT-RS subcarrier offset of 4 for a resource offset parameter value of ‘00’ for the first DMRS configuration type;
   a PT-RS subcarrier offset of 6 for a resource offset parameter value of ‘01’ for the first DMRS configuration type;
   a PT-RS subcarrier offset of 10 for a resource offset parameter value of ‘10’ for the first DMRS configuration type; and
   a PT-RS subcarrier offset of 0 for a resource offset parameter value of ‘11’ for the first DMRS configuration type;
a row associated to a DMRS port 1009 that defines:
   a PT-RS subcarrier offset of 6 for the resource offset parameter value of ‘00’ for the first DMRS configuration type;
   a PT-RS subcarrier offset of 8 for the resource offset parameter value of ‘01’ for the first DMRS configuration type;
   a PT-RS subcarrier offset of 0 for the resource offset parameter value of ‘10’ for the first DMRS configuration type; and
   a PT-RS subcarrier offset of 2 for the resource offset parameter value of ‘11’ for
a row associated to a DMRS port 1010 that defines:
   a PT-RS subcarrier offset of 5 for the resource offset parameter value of ‘00’ for the first DMRS configuration type;
   a PT-RS subcarrier offset of 7 for the resource offset parameter value of ‘01’ for the first DMRS configuration type;
   a PT-RS subcarrier offset of 11 for the resource offset parameter value of ‘10’ for the first DMRS configuration type; and
   a PT-RS subcarrier offset of 1 for the resource offset parameter value of ‘11’ for the first DMRS configuration type;
a row associated to a DMRS port 1011 that defines:
   a PT-RS subcarrier offset of 7 for the resource offset parameter value of ‘00’ for the first DMRS configuration type;
   a PT-RS subcarrier offset of 9 for the resource offset parameter value of ‘01’ for the first DMRS configuration type;
   a PT-RS subcarrier offset of 1 for the resource offset parameter value of ‘10’ for the first DMRS configuration type; and
   a PT-RS subcarrier offset of 3 for the resource offset parameter value of ‘11’ for the first DMRS configuration type;
a row associated to a DMRS port 1012 that defines:
   a PT-RS subcarrier offset of 6 for the resource offset parameter value of ‘00’ for the second DMRS configuration type;
   a PT-RS subcarrier offset of 7 for the resource offset parameter value of ‘01’ for the second DMRS configuration type;
   a PT-RS subcarrier offset of 0 for the resource offset parameter value of ‘10’ for the second DMRS configuration type; and
   a PT-RS subcarrier offset of 1 for the resource offset parameter value of ‘11’ for the second DMRS configuration type;
a row associated to a DMRS port 1013 that defines:
   a PT-RS subcarrier offset of 7 for the resource offset parameter value of ‘00’ for the second DMRS configuration type;
   a PT-RS subcarrier offset of 0 for the resource offset parameter value of ‘01’ for the second DMRS configuration type;
   a PT-RS subcarrier offset of 1 for the resource offset parameter value of ‘10’ for the second DMRS configuration type; and
   a PT-RS subcarrier offset of 6 for the resource offset parameter value of ‘11’ for the second DMRS configuration type;
a row associated to a DMRS port 1014 that defines:
   a PT-RS subcarrier offset of 8 for the resource offset parameter value of ‘00’ for the second DMRS configuration type;
   a PT-RS subcarrier offset of 9 for the resource offset parameter value of ‘01’ for the second DMRS configuration type;
   a PT-RS subcarrier offset of 2 for the resource offset parameter value of ‘10’ for the second DMRS configuration type; and
   a PT-RS subcarrier offset of 3 for the resource offset parameter value of ‘11’ for the second DMRS configuration type;
a row associated to a DMRS port 1015 that defines:
   a PT-RS subcarrier offset of 9 for the resource offset parameter value of ‘00’ for the second DMRS configuration type;
   a PT-RS subcarrier offset of 2 for the resource offset parameter value of ‘01’ for the second DMRS configuration type;
   a PT-RS subcarrier offset of 3 for the resource offset parameter value of ‘10’ for the second DMRS configuration type; and
   a PT-RS subcarrier offset of 8 for the resource offset parameter value of ‘11’ for the second DMRS configuration type;
a row associated to a DMRS port 1016 that defines:
   a PT-RS subcarrier offset of 10 for the resource offset parameter value of ‘00’ for the second DMRS configuration type;
   a PT-RS subcarrier offset of 11 for the resource offset parameter value of ‘01’ for the second DMRS configuration type;
   a PT-RS subcarrier offset of 4 for the resource offset parameter value of ‘10’ for the second DMRS configuration type; and
   a PT-RS subcarrier offset of 5 for the resource offset parameter value of ‘11’ for the second DMRS configuration type; and
a row associated to a DMRS port 1017 that defines:
   a PT-RS subcarrier offset of 11 for the resource offset parameter value of ‘00’ for the second DMRS configuration type;
   a PT-RS subcarrier offset of 4 for the resource offset parameter value of ‘01’ for the second DMRS configuration type;
   a PT-RS subcarrier offset of 5 for the resource offset parameter value of ‘10’ for the second DMRS configuration type; and
   a PT-RS subcarrier offset of 10 for the resource offset parameter value of ‘11’ for the second DMRS configuration type.

In one embodiment, the uplink table further comprises:
a row associated to a DMRS port 1000 that defines:
   a PT-RS subcarrier offset of 0 for the resource offset parameter value of ‘00’ for the first DMRS configuration type;
   a PT-RS subcarrier offset of 2 for the resource offset parameter value of ‘01’ for the first DMRS configuration type;
   a PT-RS subcarrier offset of 6 for the resource offset parameter value of ‘10’ for the first DMRS configuration type;
   a PT-RS subcarrier offset of 8 for the resource offset parameter value of ‘11’ for the first DMRS configuration type;
   a PT-RS subcarrier offset of 0 for the resource offset parameter value of ‘00’ for the second DMRS configuration type;
   a PT-RS subcarrier offset of 1 for the resource offset parameter value of ‘01’ for the second DMRS configuration type;
   a PT-RS subcarrier offset of 6 for the resource offset parameter value of ‘10’ for the second DMRS configuration type; and
   a PT-RS subcarrier offset of 7 for the resource offset parameter value of ‘11’ for the second DMRS configuration type;
a row associated to a DMRS port 1001 that defines:
   a PT-RS subcarrier offset of 2 for the resource offset parameter value of ‘00’ for the first DMRS configuration type;
   a PT-RS subcarrier offset of 4 for the resource offset parameter value of ‘01’ for the first DMRS configuration type;
   a PT-RS subcarrier offset of 8 for the resource offset parameter value of ‘10’ for the first DMRS configuration type;
   a PT-RS subcarrier offset of 10 for the resource offset parameter value of ‘11’ for the first DMRS configuration type;
   a PT-RS subcarrier offset of 1 for the resource offset parameter value of ‘00’ for the second DMRS configuration type;
   a PT-RS subcarrier offset of 6 for the resource offset parameter value of ‘01’ for the second DMRS configuration type;
   a PT-RS subcarrier offset of 7 for the resource offset parameter value of ‘10’ for the second DMRS configuration type; and
   a PT-RS subcarrier offset of 0 for the resource offset parameter value of ‘11’ for the second DMRS configuration type;
a row associated to a DMRS port 1002 that defines:
   a PT-RS subcarrier offset of 1 for the resource offset parameter value of ‘00’ for the first DMRS configuration type;
   a PT-RS subcarrier offset of 3 for the resource offset parameter value of ‘01’ for the first DMRS configuration type;
   a PT-RS subcarrier offset of 7 for the resource offset parameter value of ‘10’ for the first DMRS configuration type;
   a PT-RS subcarrier offset of 9 for the resource offset parameter value of ‘11’ for the first DMRS configuration type;
   a PT-RS subcarrier offset of 2 for the resource offset parameter value of ‘00’ for the second DMRS configuration type;
   a PT-RS subcarrier offset of 3 for the resource offset parameter value of ‘01’ for the second DMRS configuration type;
   a PT-RS subcarrier offset of 8 for the resource offset parameter value of ‘10’ for the second DMRS configuration type; and
   a PT-RS subcarrier offset of 9 for the resource offset parameter value of ‘11’ for the second DMRS configuration type;
a row associated to a DMRS port 1003 that defines:
   a PT-RS subcarrier offset of 3 for the resource offset parameter value of ‘00’ for the first DMRS configuration type;
   a PT-RS subcarrier offset of 5 for the resource offset parameter value of ‘01’ for the first DMRS configuration type;
   a PT-RS subcarrier offset of 9 for the resource offset parameter value of ‘10’ for the first DMRS configuration type;
   a PT-RS subcarrier offset of 11 for the resource offset parameter value of ‘11’ for the first DMRS configuration type;
   a PT-RS subcarrier offset of 3 for the resource offset parameter value of ‘00’ for the second DMRS configuration type;
   a PT-RS subcarrier offset of 8 for the resource offset parameter value of ‘01’ for the second DMRS configuration type;
   a PT-RS subcarrier offset of 9 for the resource offset parameter value of ‘10’ for the second DMRS configuration type; and
   a PT-RS subcarrier offset of 2 for the resource offset parameter value of ‘11’ for the second DMRS configuration type;
a row associated to a DMRS port 1004 that defines:
   a PT-RS subcarrier offset of 4 for the resource offset parameter value of ‘00’ for the second DMRS configuration type;
   a PT-RS subcarrier offset of 5 for the resource offset parameter value of ‘01’ for the second DMRS configuration type;
   a PT-RS subcarrier offset of 10 for the resource offset parameter value of ‘10’ for the second DMRS configuration type; and
   a PT-RS subcarrier offset of 11 for the resource offset parameter value of ‘11’ for the second DMRS configuration type; and
a row associated to a DMRS port 1005 that defines:
   a PT-RS subcarrier offset of 5 for the resource offset parameter value of ‘00’ for the second DMRS configuration type;
   a PT-RS subcarrier offset of 10 for the resource offset parameter value of ‘01’ for the second DMRS configuration type;
   a PT-RS subcarrier offset of 11 for the resource offset parameter value of ‘10’ for the second DMRS configuration type; and
   a PT-RS subcarrier offset of 4 for the resource offset parameter value of ‘11’ for the second DMRS configuration type.

In one embodiment, the PT-RS port is mapped to one DMRS subcarrier of the associated DMRS port in each of the one or more RBs allocated to the PT-RS port, wherein the one DMRS subcarrier to which the PT-RS port is mapped in the each RB is defined as a function of the determined PT-RS subcarrier offset.

In one embodiment, the PT-RS subcarrier offset is with respect to a subcarrier with the lowest frequency in each of the one or more RBs.

In one embodiment, for a PDSCH or a PUSCH scheduled with N_{RB} (≥1) RBs, the corresponding

$${N}_{sc}^{RB} {N}_{RB}$$

subcarriers in the N_{RB} RBs are numbered in increasing order starting from the lowest frequency from 0 to

$${N}_{sc}^{RB} {N}_{RB} - 1$$

and subcarriers to which PTRS port is mapped in the N_{RB} RBs are given by:

$$k = {k}_{ref}^{RE} + ( {iK}_{PT - RS} + {k}_{ref}^{RB} ) {N}_{sc}^{RB}$$

$$wherein :$$

$${k}_{ref}^{RE}$$

is the PT-RS subcarrier offset;
i=0,1,2, . . .
K_{PT-RS} is a frequency density of PT-RS and K_{PT-RS}∈{2,4}

$${k}_{ref}^{RB}$$

is the RB offset for PT-RS and is given by

$${k}_{ref}^{RB} = \{ \begin{matrix}{n}_{RNTI} mod {K}_{PT - RS} & if {N}_{RB} mod {K}_{PT - RS} = 0 \\ {n}_{RNTI} mod ( {N}_{RB} mod {K}_{PT - RS} ) & otherwise\end{matrix}$$

$${N}_{sc}^{RB}$$

is the number of subcarriers per RB
n_{RNTI} is the RNTI associated with the DCI scheduling the transmission.

In one embodiment, the UE can be scheduled such that a number of consecutively scheduled RBs for the UE in the downlink is odd, and only PT-RS subcarrier offsets in a range of and including 0 to 7 are allowed. In one embodiment, the RB is scheduled for downlink, and the determined PT-RS subcarrier offset is outside of the allowed range of and including 0 to 7, and, based thereon, the UE assumes that PT-RS is not present in the RB. In another embodiment, the RB is scheduled for downlink, and the determined PT-RS subcarrier offset is outside of the allowed range of and including 0 to 7, and, based thereon, the UE assumes that PT-RS is not present in an RB with a lowest index among each set of consecutively scheduled RBs and assumes PT-RS is present in the remaining RBs. In another embodiment, the RB is scheduled for downlink, and the determined PT-RS subcarrier offset is outside of the allowed range of and including 0 to 7, and, based thereon, the UE assumes that PT-RS is not present in in the RB if the RB is associated with orphaned resource elements. In another embodiment, the RB is scheduled for downlink, and the determined PT-RS subcarrier offset is outside of the allowed range of and including 0 to 7, and, based thereon, the UE does not transmit PT-RS in the RB. In another embodiment, the RB is scheduled for downlink, and the determined PT-RS subcarrier offset is outside of the allowed range of and including 0 to 7, and, based thereon, the UE does not transmit PT-RS in an RB having a highest index among each set of consecutively scheduled RBs and transmits PT-RS in the remaining RBs. In another embodiment, the RB is scheduled for downlink, and the determined PT-RS subcarrier offset is outside of the allowed range of and including 0 to 7, and, based thereon, the UE does not transmit PT-RS in an RB having a lowest index among each set of consecutively scheduled RBs and transmits PT-RS in the remaining RBs.

Corresponding embodiments of a UE are also disclosed. In one embodiment, a UE for a wireless communications system is adapted to, for each RB of one or more RBs allocated for a PT-RS port configured for the UE, determine a PT-RS subcarrier offset for the PT-RS port from a table based on a DMRS port associated to the PT-RS port, a DMRS configuration type, and a resource element offset parameter configured for the UE. The DMRS port associated to the PT-RS port is one of a plurality of DMRS ports, wherein eight of the plurality of DMRS ports are associated to a first DMRS configuration type and twelve of the plurality of DMRS ports are associated to a second DMRS configuration type. Each row of the table is associated with one of the plurality of DMRS ports and defines different PT-RS subcarrier offsets for a PT-RS port associated to the one of the plurality of DMRS ports for different resource element offset parameter values for at least one of the first DMRS configuration type and the second DMRS configuration type. The UE is further adapted to, for each RB of the one or more RBs allocated for the PT-RS port configured for the UE, transmitting or receiving a PT-RS on the PT-RS port in the RB in accordance with the determined PT-RS subcarrier offset. In this manner, phase tracking with PT-RS for PDSCH or PUSCH with up to eight layers is enabled by allocating proper sub-carrier offsets.

In one embodiment, a UE for a wireless communications system comprises a communication interface comprising a transmitter and a receiver, and processing circuitry associated with the communication interface. The processing circuitry is configured to cause the UE to, for each RB of one or more RBs allocated for a PT-RS port configured for the UE, determine a PT-RS subcarrier offset for the PT-RS port from a table based on a DMRS port associated to the PT-RS port, a DMRS configuration type, and a resource element offset parameter configured for the UE. The DMRS port associated to the PT-RS port is one of a plurality of DMRS ports, wherein eight of the plurality of DMRS ports are associated to a first DMRS configuration type and twelve of the plurality of DMRS ports are associated to a second DMRS configuration type. Each row of the table is associated with one of the plurality of DMRS ports and defines different PT-RS subcarrier offsets for a PT-RS port associated to the one of the plurality of DMRS ports for different resource element offset parameter values for at least one of the first DMRS configuration type and the second DMRS configuration type. The processing circuitry is further configured to cause the UE to, for each RB of the one or more RBs allocated for the PT-RS port configured for the UE, transmitting or receiving a PT-RS on the PT-RS port in the RB in accordance with the determined PT-RS subcarrier offset. In this manner, phase tracking with PT-RS for PDSCH or PUSCH with up to eight layers is enabled by allocating proper sub-carrier offsets.

Embodiments of a method performed by a network node in a wireless communications system are also disclosed. In one embodiment, a method comprises, for each RB of one or more RBs allocated for a PT-RS port configured for the UE, determining a PT-RS subcarrier offset for the PT-RS port from a table based on a DMRS port associated to the PT-RS port, a DMRS configuration type, and a resource element offset parameter configured for the UE. The DMRS port associated to the PT-RS port is one of a plurality of DMRS ports, wherein eight of the plurality of DMRS ports are associated to a first DMRS configuration type and twelve of the plurality of DMRS ports are associated to a second DMRS configuration type. Each row of the table is associated with one of the plurality of DMRS ports and defines different PT-RS subcarrier offsets for a PT-RS port associated to the one of the plurality of DMRS ports for different resource element offset parameter values for at least one of the first DMRS configuration type and the second DMRS configuration type. The method further comprises, for each RB of the one or more RBs allocated for the PT-RS port configured for the UE, transmitting or receiving a PT-RS on the PT-RS port in the RB in accordance with the determined PT-RS subcarrier offset. In this manner, phase tracking with PT-RS for PDSCH or PUSCH with up to eight layers is enabled by allocating proper sub-carrier offsets.

Embodiments of a method performed by a transmitting node in a wireless communications system are also disclosed. In one embodiment, a method performed by a transmitting node in a wireless communications system comprises determining a PT-RS to Physical Downlink/Uplink Shared Channel (PxSCH) power ratio per spatial layer per Resource Element (RE) for a scheduled PxSCH transmission for a UE, wherein the PxSCH transmission has up to 8 spatial layers and is over more than 4 antenna ports. The method further comprises transmitting the scheduled PxSCH transmission with up to 8 layers and transmitting, together with the PxSCH transmission, a PT-RS on a PT-RS port at a transmit power in accordance with the determined PT-RS to PxSCH power ratio per spatial layer per RE.

In one embodiment, the PxSCH transmission is a Physical Downlink Shared Channel, PDSCH, transmission with 7 or 8 layers, the determined PT-RS to PxSCH power ratio per spatial layer per RE is a PT-RS to PDSCH power ratio per spatial layer per RE, and the transmitting node is a network node in the wireless communication system.

In one embodiment, determining the PT-RS to PDSCH power ratio per spatial layer per RE for the scheduled PDSCH transmission is based on a table that defines a plurality of PT-RS to PDSCH power ratio per spatial layer per RE values for a respective plurality of number of PDSCH spatial layer values, wherein the plurality of number of PDSCH spatial layer values comprises 1, 2, 3, 4, 5, 6, 7, and 8. In one embodiment, each of one or more rows of the table corresponds to a value of a downlink PT-RS configuration parameter ‘EPRE-ratio’, wherein ‘EPRE-ratio’ is signaled to the UE from the network node and can have an integer value from 0 to 3.

In one embodiment, the table defines a PT-RS to PDSCH power ratio per spatial layer per RE value of 8.45 for a case in which the PDSCH transmission consists of 7 spatial layers and a PT-RS to PDSCH power ratio per spatial layer per RE value of 9 for a case in which the PDSCH transmission consists of 8 spatial layers. In one embodiment, the table further defines a PT-RS to PDSCH power ratio per spatial layer per RE value of 0 for a case in which the PDSCH transmission consists of 1 spatial layer, a PT-RS to PDSCH power ratio per spatial layer per RE value of 3 for a case in which the PDSCH transmission consists of 2 spatial layers, a PT-RS to PDSCH power ratio per spatial layer per RE value of 4.77 for a case in which the PDSCH transmission consists of 3 spatial layers, a PT-RS to PDSCH power ratio per spatial layer per RE value of 6 for a case in which the PDSCH transmission consists of 4 spatial layers, a PT-RS to PDSCH power ratio per spatial layer per RE value of 7 for a case in which the PDSCH transmission consists of 5 spatial layers, and a PT-RS to PDSCH power ratio per spatial layer per RE value of 7.78 for a case in which the PDSCH transmission consists of 6 spatial layers.

In one embodiment, the PT-RS to PDSCH power ratio per spatial layer per RE value for n (n=7,8) PDSCH spatial layers in one of the one or more rows is given by 10 log₁₀(n).

In one embodiment, determining the PT-RS to PDSCH power ratio per spatial layer per RE for the scheduled PDSCH transmission with 7 or 8 spatial layers comprises determining a row in the table based on the configured parameter ‘EPRE-ratio’ and determining a PT-RS to PDSCH power ratio per spatial layer per RE value in the determined row based on the number of spatial layers of the PDSCH.

In one embodiment, the PxSCH transmission is a PUSCH transmission with up to 8 layers and over up to 8 antenna ports at the UE, the determined PT-RS to PxSCH power ratio per spatial layer per RE is a PT-RS to PUSCH power ratio per spatial layer per RE, and the transmitting node is the UE.

In one embodiment, determining the PT-RS to PUSCH power ratio per spatial layer per RE for the scheduled PUSCH transmission is based on a table that defines a plurality of PT-RS to PUSCH power ratio per spatial layer per RE values for a respective plurality of number of PUSCH spatial layer values, wherein the plurality of number of PDSCH spatial layer values comprises 1, 2, 3, 4, 5, 6, 7, and 8. In one embodiment, each of one or more rows of the table corresponds to a value of an uplink configuration parameter ‘UL-PTRS-power’ received by the UE from a network node. In one embodiment, for full coherent PUSCH transmission over the up to 8 antenna ports, each of the plurality of PT-RS to PUSCH power ratio per spatial layer per RE values in at least one of the one or more rows in the table is computed based on the respective number of PUSCH spatial layers associated to the PT-RS port as defined by:

$${α}_{PTRS}^{PUSCH} = 10 log 10 ( {n}_{layer}^{PUSCH} ) ( dB )$$

$$where {α}_{PTRS}^{PUSCH}$$

is the PT-RS to PUSCH power ratio per spatial layer per RE and

$${n}_{layer}^{PUSCH}$$

is the number of spatial layers in the PUSCH transmission. In one embodiment, for non-coherent PUSCH transmission over the up to 8 antenna ports, each spatial layer of the PUSCH transmission is transmitted on only one of the up to 8 antenna ports, and each of the plurality of PT-RS to PUSCH power ratio per spatial layer per RE values in at least one of the one or more rows in the table is computed based on a number of PT-RS ports scheduled for the PUSCH as defined by:

$${α}_{PTRS}^{PUSCH} = 10 log 10 ( {Q}_{p} ) ( dB )$$

$$where {α}_{PTRS}^{PUSCH}$$

is the PT-RS to PUSCH power ratio per spatial layer per RE and Qₚ is a number of PT-RS ports scheduled for the PUSCH transmission. In one embodiment, for partially coherent PUSCH transmission over the up to 8 antenna ports, the up to 8 antenna ports of the UE are divided into two or more antenna port groups and PUSCH transmission in each of the groups is coherent, and each of the plurality of PT-RS to PUSCH power ratio per spatial layer per RE values in at least one of the one or more rows in the table is computed based on a respective number of PUSCH spatial layers in a same antenna group as the PT-RS as defined by:

$${α}_{PTRS}^{PUSCH} = 10 log 10 ( {n}_{layer , k}^{PUSCH} {Q}_{p} ) ( dB )$$

$$where {α}_{PTRS}^{PUSCH}$$

is the PT-RS to PUSCH power ratio per spatial layer per RE,

$${n}_{layer , k}^{PUSCH}$$

is the number of spatial layers of the PUSCH transmission transmitted in a same antenna port group as the PT-RS, and Qₚ is a number of PT-RS ports scheduled for the PUSCH transmission.

In one embodiment, determining the PT-RS to PUSCH power ratio per spatial layer per RE for the scheduled PUSCH transmission comprises determining a row in the table based on the configured parameter ‘UL-PTRS-power’, and whether the PUSCH transmission is fully coherent, non-coherent, or partially coherent, and determining a PT-RS to PUSCH power ratio per spatial layer per RE value based on a respective number of spatial layers of the PUSCH transmission on antenna ports associated to the PT-RS port.

Corresponding embodiments of a transmitting node for a wireless communications system are also disclosed. In one embodiment, a transmitting node for a wireless communications system is adapted to determine a PT-RS to PxSCH power ratio per spatial layer per RE for a scheduled PxSCH transmission for a UE, wherein the PxSCH transmission has up to 8 spatial layers and is over more than 4 antenna ports. The transmitting node is further adapted to transmit the scheduled PxSCH transmission with up to 8 layers and transmitting, together with the PxSCH transmission, a PT-RS on a PT-RS port at a transmit power in accordance with the determined PT-RS to PxSCH power ratio per spatial layer per RE.

In one embodiment, a transmitting node for a wireless communications system comprises processing circuitry configured to cause the transmitting node to determine a PT-RS to PxSCH power ratio per spatial layer per RE for a scheduled PxSCH transmission for a UE, wherein the PxSCH transmission has up to 8 spatial layers and is over more than 4 antenna ports.

The processing circuitry is further configured to cause the transmitting node to transmit the scheduled PxSCH transmission with up to 8 layers and transmitting, together with the PxSCH transmission, a PT-RS on a PT-RS port at a transmit power in accordance with the determined PT-RS to PxSCH power ratio per spatial layer per RE.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1A illustrates an example of a New Radio (NR) slot;

FIG. 1B illustrates one example of a Resource Block (RB) in NR;

FIG. 1C illustrates Phase Tracking Reference Signal (PT-RS) downlink and uplink configuration information elements a defined in 3rd Generation Partnership Project (3GPP) Technical Specification (TS) 38.331 v17.2.0;

FIG. 1D illustrates an example of PT-RS Resource Elements (REs) in a PT-RS RB for time domain density of ½, where the PT-RS port is associated with type 1 Demodulation Reference Signal (DMRS) port 1 and the Radio Resource Control (RRC) parameter resourceElementOffset is configured as ‘offset10’ with a single symbol DMRS in the RB (left side of FIG. 1D) and a double symbol DMRS in the RB (right side of FIG. 1D);

FIG. 1E illustrates an example in which a PT-RS port is associated with a single symbol type 1 DMRS port 1 (shown on the left side of FIG. 1E) and a single symbol type 2 DMRS port 1 (shown on the right side of FIG. 1E), and again both with the RRC parameter resourceElementOffset configured as ‘offset10’ but with a PTRS time density of L=1;

FIG. 2A illustrates the relation of DMRS ports and Code Division Multiplexing (CDM) groups for Physical Uplink Shared Channel (PUSH) for type 1 DMRS;

FIG. 2B illustrates the relation of DMRS ports and CDM groups for PUSH for type 2 DMRS;

FIG. 2C illustrates the case where the number of DMRS ports per CDM group is doubled for type 1 DMRS;

FIG. 2D illustrates the case where the number of DMRS ports per CDM group is doubled for type 2 DMRS;

FIG. 2E illustrates an example of a table that defines a downlink PT-RS subcarrier offset for an increased number of DMRS ports for type 1 and type 2 DMRS, in accordance with one embodiment of the present disclosure;

FIG. 2F illustrates an example of a table that defines an uplink PT-RS subcarrier offset for an increased number of DMRS ports for type 1 and type 2 DMRS, in accordance with one embodiment of the present disclosure;

FIG. 3A shows an example corresponding to an allowed combination of ‘offset01’ and DMRS antenna port p=3 in which case the sub-carrier offset is

$${k}_{ref}^{RE} = 5 ,$$

in accordance with one example embodiment of the present disclosure;

FIG. 3B illustrates an example of a new parameter introduced in RRC to set a downlink PT-RS subcarrier offset separately for Rel-18 DMRS compared to Rel-15 DMRS, in accordance with one embodiment of the present disclosure;

FIG. 3C illustrates an example of a new parameter introduced in RRC to set an uplink PT-RS subcarrier offset separately for Rel-18 DMRS compared to Rel-15 DMRS;

FIG. 4A-1 illustrates an example table that defines PT-RS to PDSCH transmit power ratio per layer per RE for PDSCH having up to eight spatial layers, in accordance with one embodiment of the present disclosure;

FIG. 4A-2 illustrates an example table that defines PT-RS to PUSCH transmit power ratio per layer per RE for PUSCH having up to eight spatial layers for the case of a fully coherent codebook, in accordance with one embodiment of the present disclosure;

FIG. 4A-3 illustrates an example in which two PT-RS ports are scheduled and 3 decibel (dB) power boosting can be achieved for each of the PT-RS ports, in accordance with an embodiment of the present disclosure;

FIG. 4A-4 illustrates an example table that defines PT-RS to PUSCH transmit power ratio per layer per RE for PUSCH having up to eight spatial layers for the case of a non-coherent codebook, in accordance with one embodiment of the present disclosure;

FIG. 4B-1 illustrates an example in which a transmitting node has eight antenna ports that are divided into two antenna port groups;

FIG. 4B-2 illustrates an example in which a transmitting node has eight antenna ports that are divided into four antenna port groups;

FIG. 4C-1 illustrates an example table that defines PT-RS to PUSCH transmit power ratio per layer per RE for PUSCH having up to four spatial layers in as same antenna port group as a PT-RS port for the case of a partially-coherent codebook, in accordance with one embodiment of the present disclosure;

FIG. 4C-2 illustrates an example of mixed partially coherent and non-coherent codebook, where each PUSCH layer in port group 1 is transmitted on only a single antenna port while each PUSCH layer scheduled in each of the other groups are transmitted on all antenna ports in the group;

FIG. 4C-3 illustrates an example table that defines PT-RS to PUSCH transmit power ratio per layer per RE for PUSCH having up to four spatial layers in as same antenna port group as a PT-RS port for the case of a partially-coherent codebook, in accordance with another embodiment of the present disclosure;

FIG. 4C-4 illustrates one example of a PT-RS to PUSCH EPRE power ratio table for two antenna groups, where the maximum number of PT-RS ports are equal to 2, i.e., Qₚ∈{1,2}, in accordance with an embodiment of the present disclosure;

FIG. 4C-5 illustrates one example of a how one or more entries of a PT-RS to PUSCH EPRE power ratio table for an 8 TX UE with 4 antenna groups, where the maximum number of PTRS ports are equal to 2, i.e., Q_p∈{1,2}, and each PT-RS port is associated with two antenna groups, in accordance with an embodiment of the present disclosure;

FIG. 4C-6 illustrates an example different PT-RS to PUSCH EPRE power ratio tables used for different numbers of scheduled PTRS ports, in accordance with an embodiment of the present disclosure;

FIG. 5A illustrates a method performed in a wireless communication system for allocating a subcarrier offset for a phase tracking reference signal PT-RS port in each resource block RB allocated for the PT-RS port, wherein when both PT-RS and Rel 18 DMRS ports are configured for a user equipment UE, a PT-RS port is associated with one of the 8 type 1 DMRS ports or 12 type 2 DMRS ports;

FIG. 5B is a flow chart that illustrates the operation of a User Equipment (UE) or network node (e.g., base station such as, e.g., a gNB) for PT-RS subcarrier offset allocation for each RB allocated for a PT-RS port, wherein both PT-RS and DMRS ports are configured for the UE, in accordance with an embodiment of the present disclosure;

FIG. 5C illustrates a method in a wireless communication system for determining phased tracking reference signal PT-RS to physical downlink shared channel PDSCH or physical uplink shared channel PUSCH power ratio per layer per resource element RE, wherein both PT-RS and Rel 18 DMRS ports are configured for a UE, and a PDSCH or PUSCH is scheduled with up to 8 layers;

FIG. 5D illustrates the operation of a transmitting node (i.e., a UE in the case of uplink or a network node (e.g., a base station or gNB) in the case of downlink) in accordance with one embodiment of the present disclosure;

FIG. 6 shows an example of a communication system in accordance with some embodiments;

FIG. 7 shows a UE in accordance with some embodiments;

FIG. 8 shows a network node in accordance with some embodiments;

FIG. 9 is a block diagram of a host, which may be an embodiment of the host of FIG. 6, in accordance with various aspects described herein;

FIG. 10 is a block diagram illustrating a virtualization environment in which functions implemented by some embodiments may be virtualized; and

FIG. 11 shows a communication diagram of a host communicating via a network node with a 1106 over a partially wireless connection in accordance with some embodiments.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Certain challenges exist. In existing New Radio (NR) up to release 17, a Phase Tracking Reference Signal (PT-RS or PTRS) can be configured with a Physical Downlink Shared Channel (PDSCH) up to four layers with type 1 Demodulation Reference Signal (DMRS) and up to six layers with type 2 DMRS, and with a Physical Uplink Shared Channel (PUSCH) up to four layers. With increased number of DMRS ports in NR Rel-18, how to allocate PT-RS subcarriers when a PT-RS port is associated with one of the new DMRS ports in NR Rel-18 is an issue. Another issue is how to allocate PT-RS to PDSCH or PUSCH power ratio per Resource Element (RE) per layer when a PT-RS can be associated to a PDSCH with more than six layers or DMRS ports or to a PUSCH with up to eight layers transmitted over up to eight antenna ports.

Certain aspects of the disclosure and their embodiments may provide solutions to these or other challenges. Some embodiments of the current disclosure provide a method for allocating sub-carrier offsets for PT-RS ports associated to the new NR Rel-18 DMRS ports where the existing rows in Table 7.4.1.2.2-1 of 3GPP TS 38.211 for downlink (DL) (reproduced herein as Table 1) and in Table 6.4.1.2.2.1-1 of 3GPP TS 38.211 for uplink (UL) (reproduced herein as Table 2) are reused for Rel-18 DMRS ports with the same port indices while new rows are added for rest of the Rel-18 DMRS ports. For a given value of the Radio Resource Control (RRC) parameter “resourceElementOffset”, different sub-carrier offsets are allocated to PT-RS associated to different DMRS ports.

Some embodiments of the current disclosure provide a method for allocating PT-RS to PDSCH power ratio per layer per RE for PDSCH with 7 and 8 layers and PT-RS to PUSCH power ratio per layer per RE for PUSCH with more than four transmit (Tx) antenna ports and up to eight layers.

According to some embodiments of the current disclosure, when both PT-RS and Rel-18 DMRS ports are configured for a UE, a PT-RS port can be associated with one of the eight type 1 DMRS ports or twelve type 2 DMRS ports.

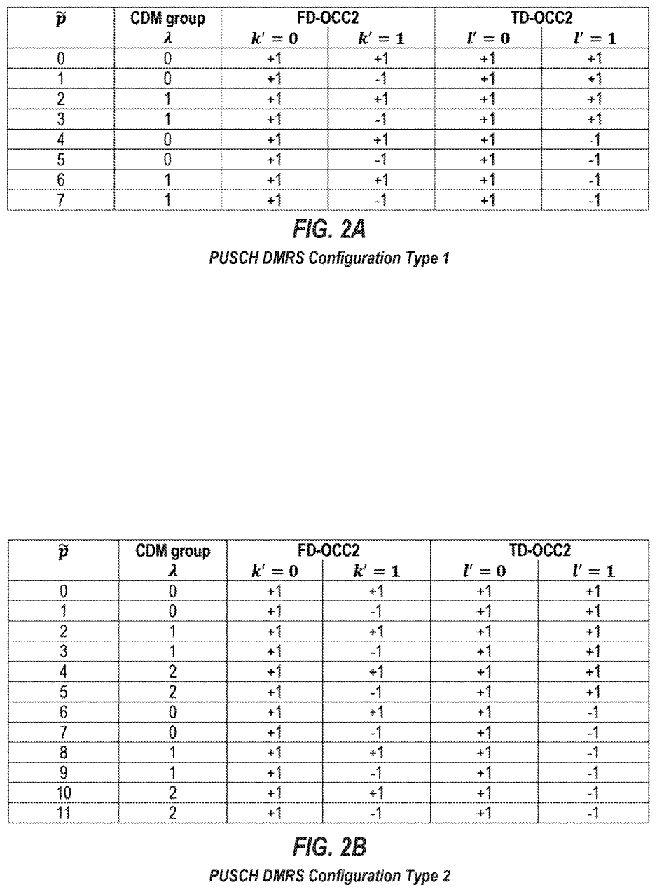

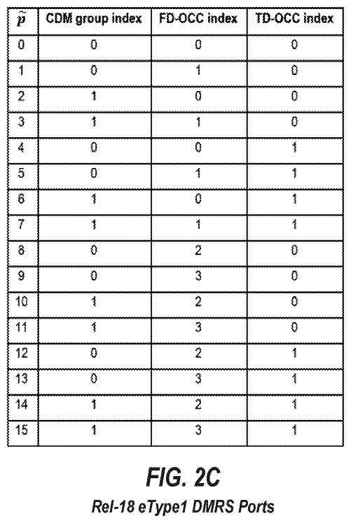

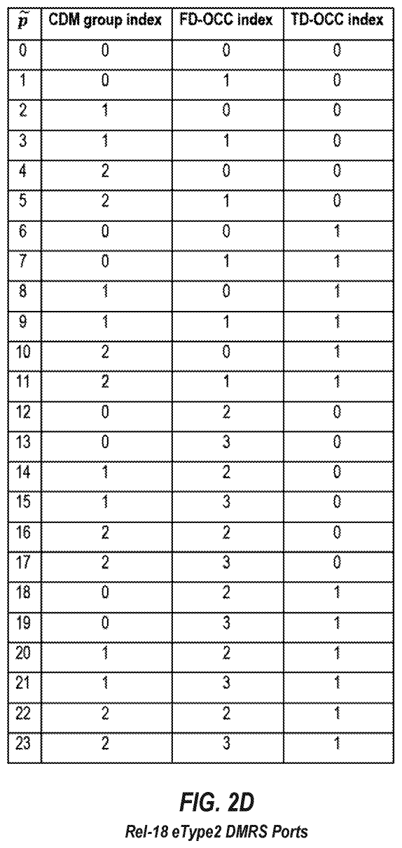

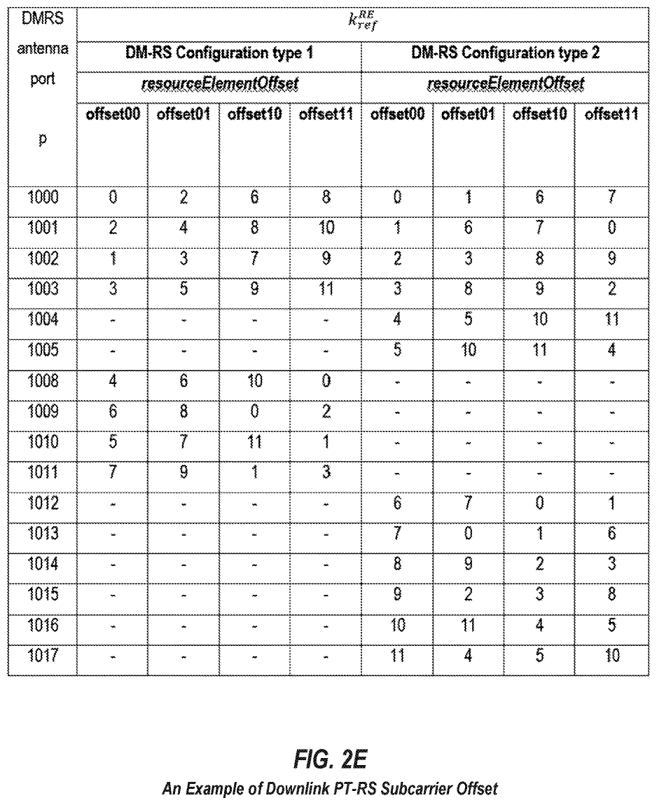

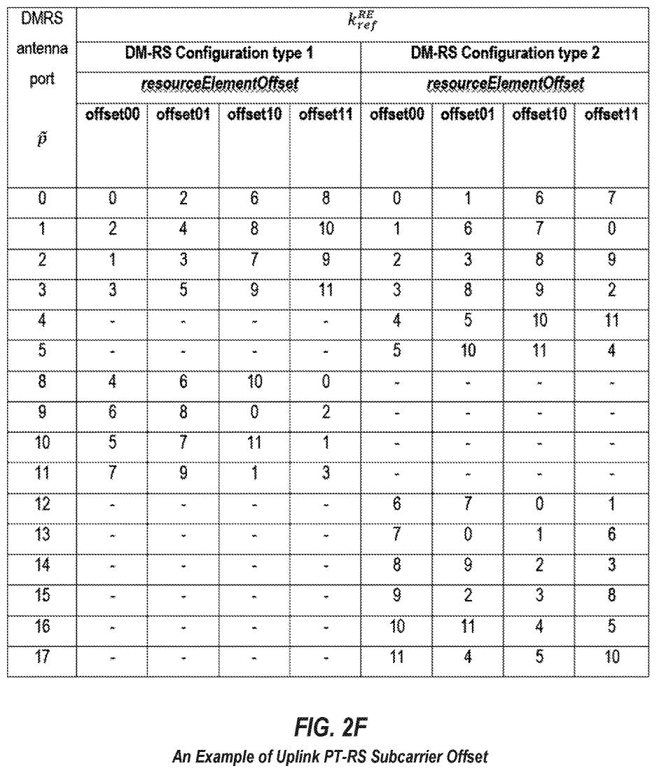

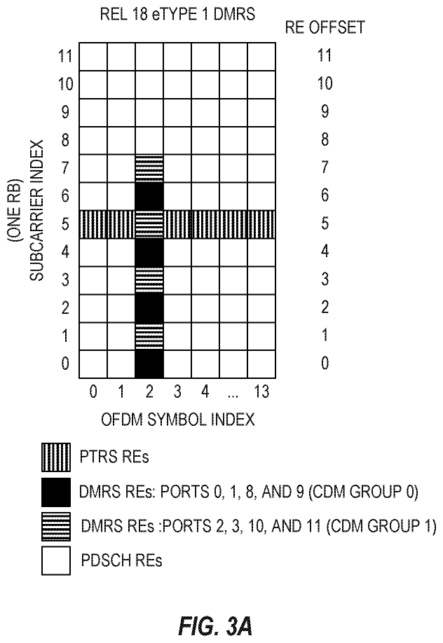

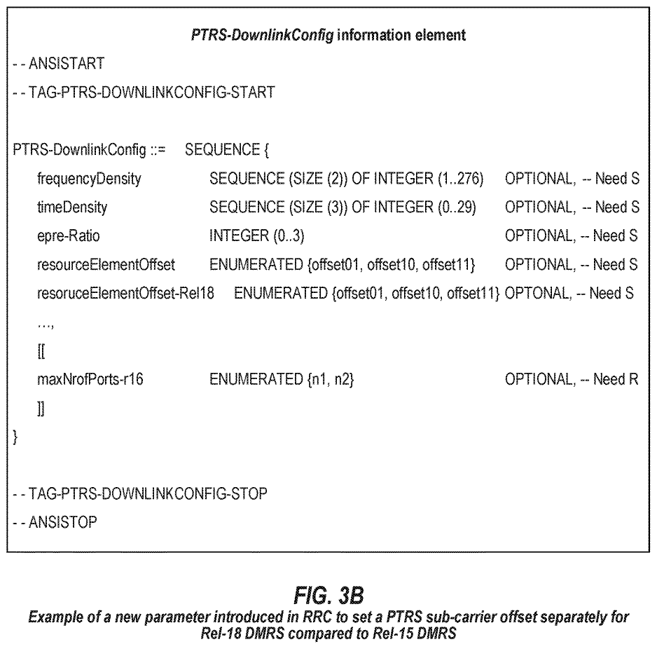

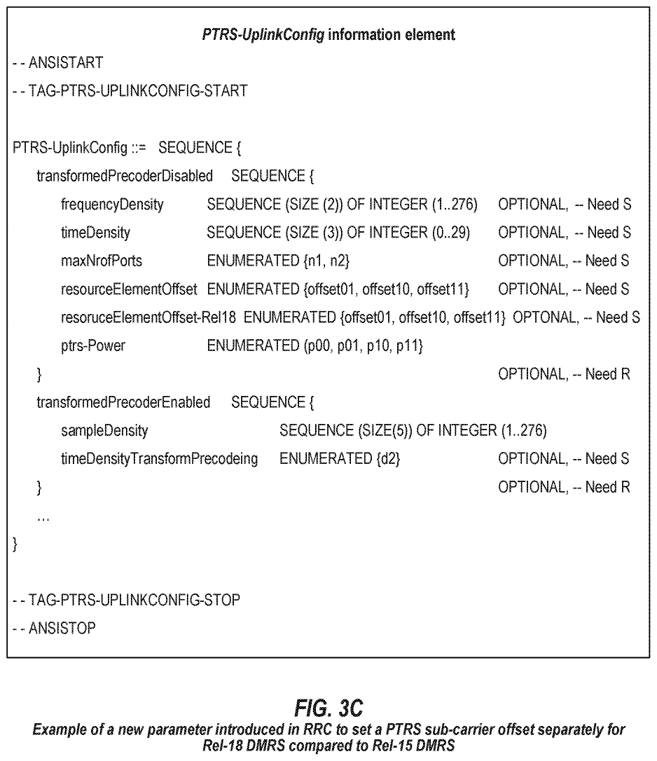

According to some embodiments of the current disclosure, a method is provided for allocating a subcarrier offset for a PT-RS port in each Resource Block (RB) allocated for the PT-RS port, the method comprising:
defining a table for DL (e.g., FIG. 2E) and a table for UL (e.g., FIG. 2F), where each row is associated with a DMRS port for which the PT-RS is associated with
for a given associated DMRS port of either type 1 or type 2, and a higher layer configuration of “resourceElementOffset” value, the PT-RS sub-carrier offset can be determined from one of the tables
UE capability: support PTRS for orphan RB in case of type 1 DMRS (e.g., FIG. 3A)

According to some embodiments of the current disclosure, when both PT-RS and Rel-18 DMRS ports are configured for a UE, a PDSCH or PUSCH is scheduled with up to eight layers.

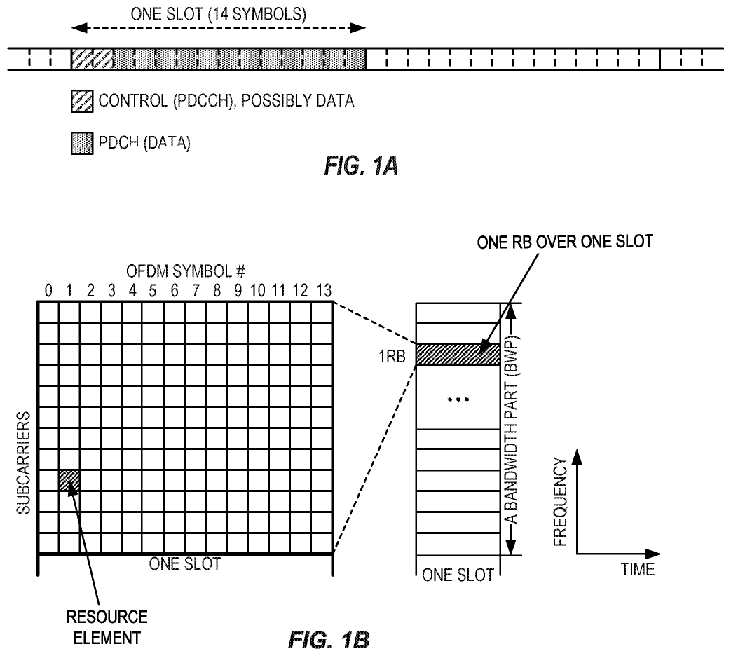

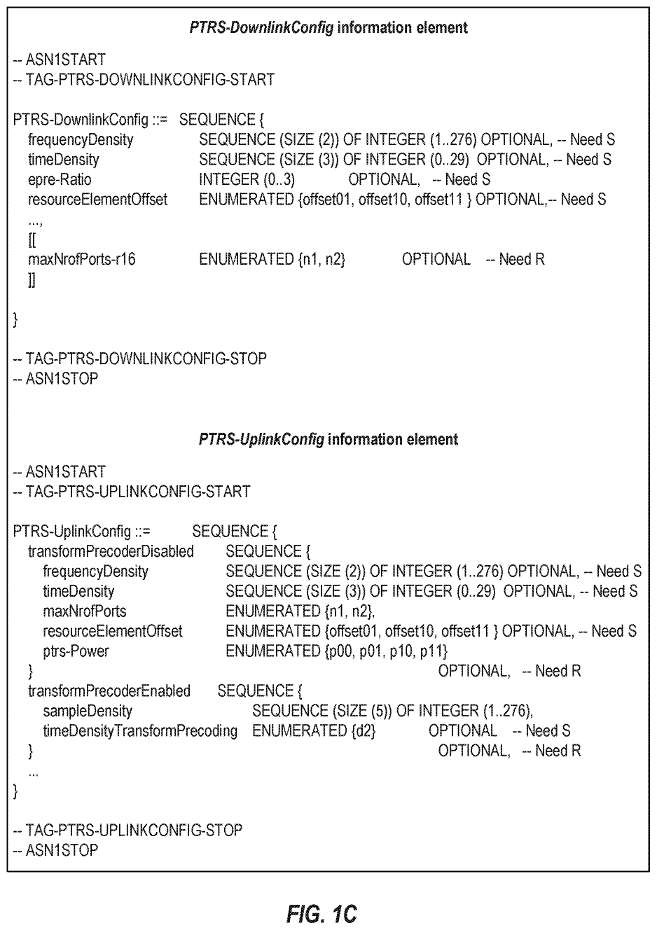

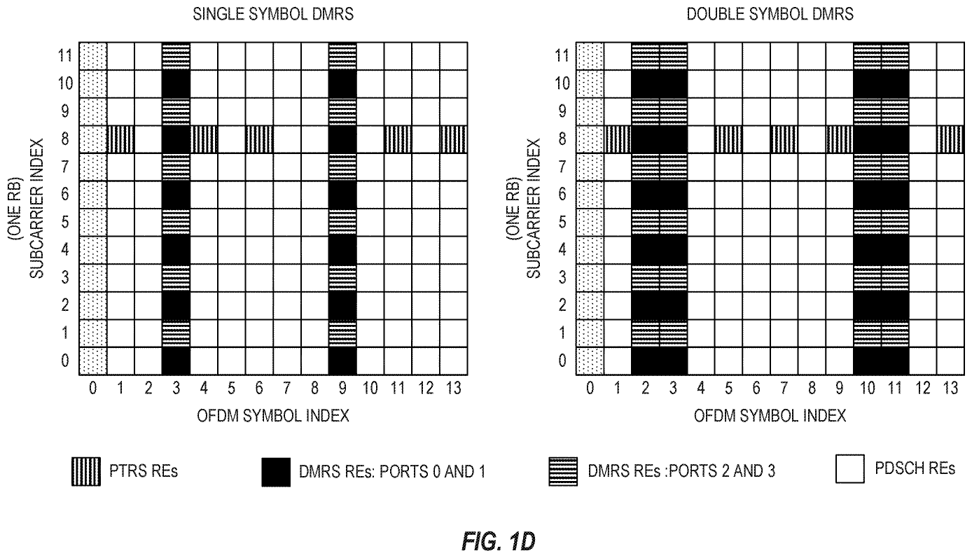

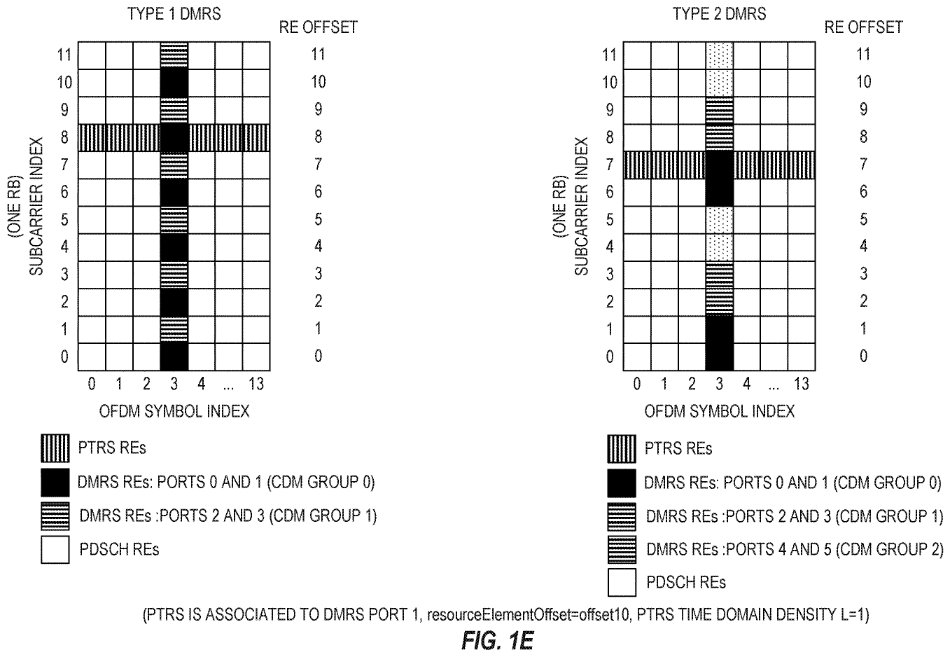

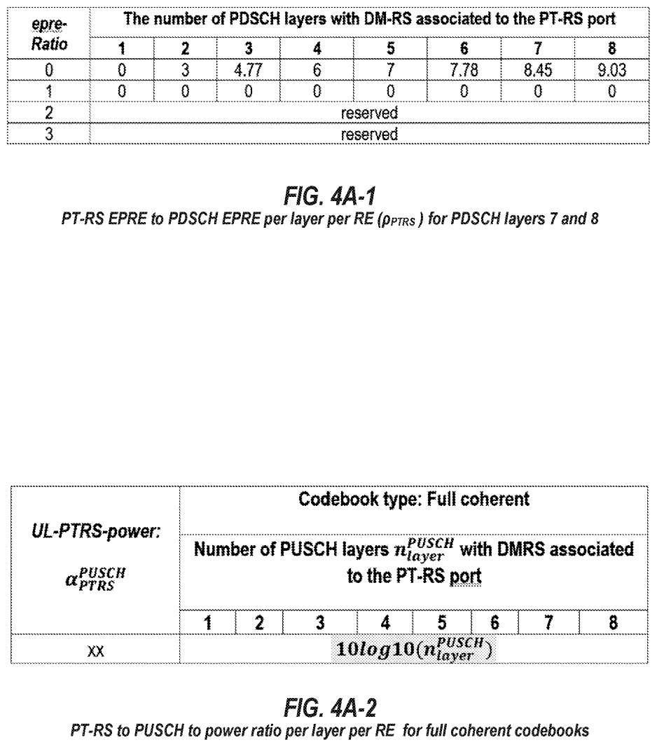

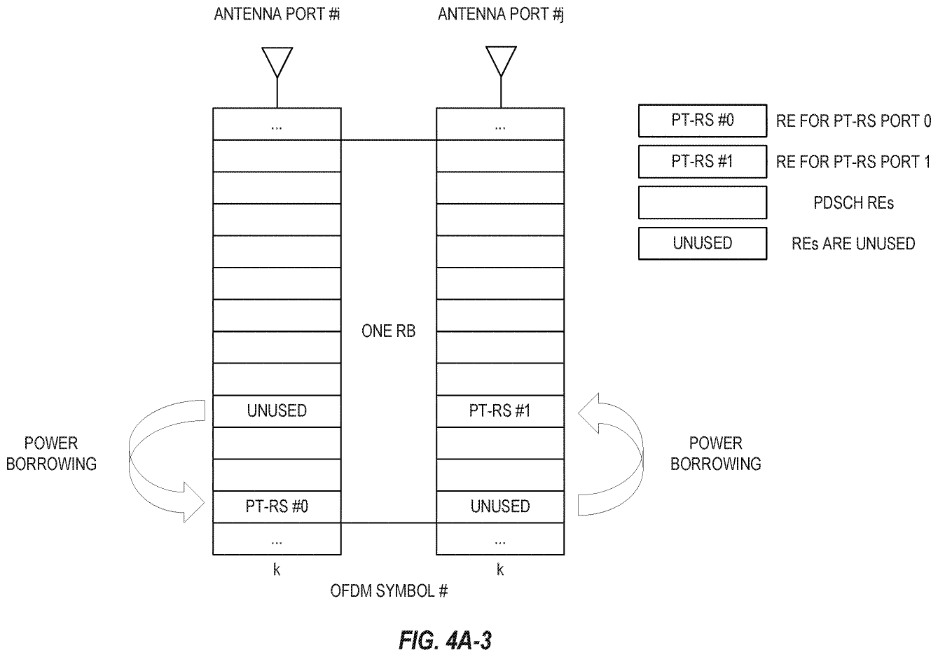

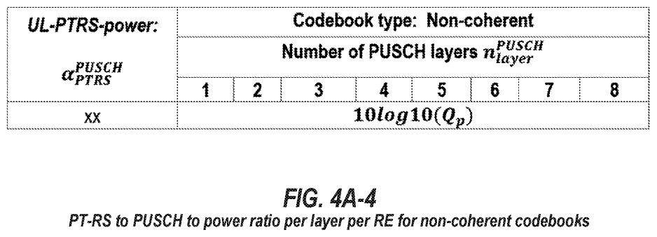

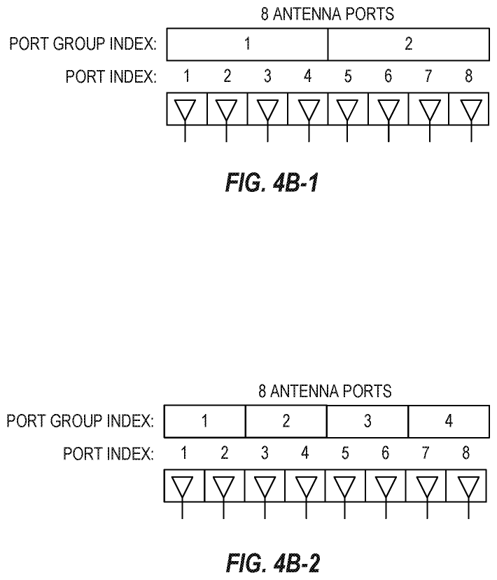

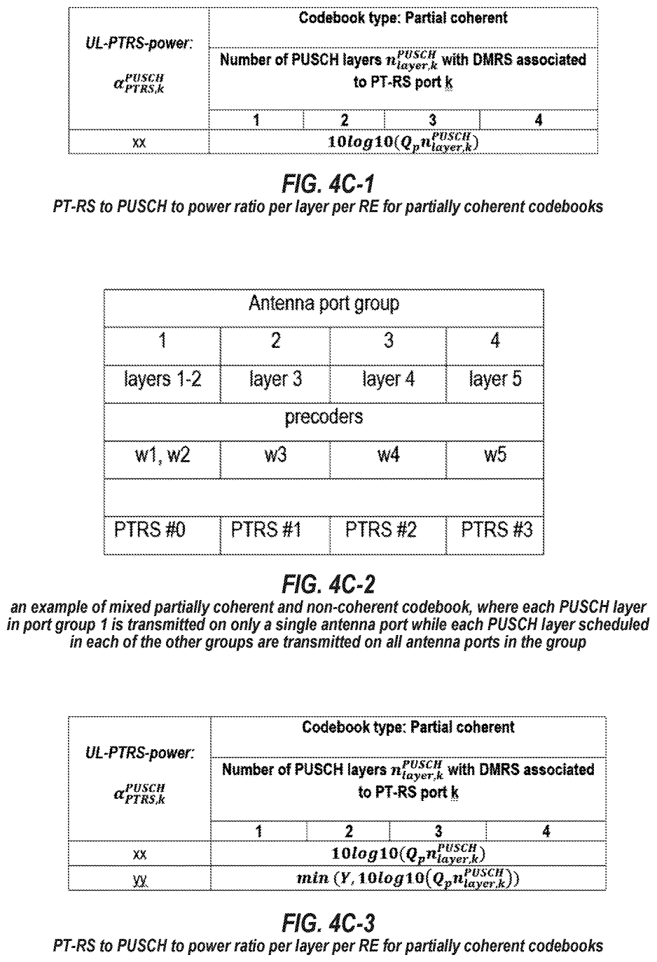

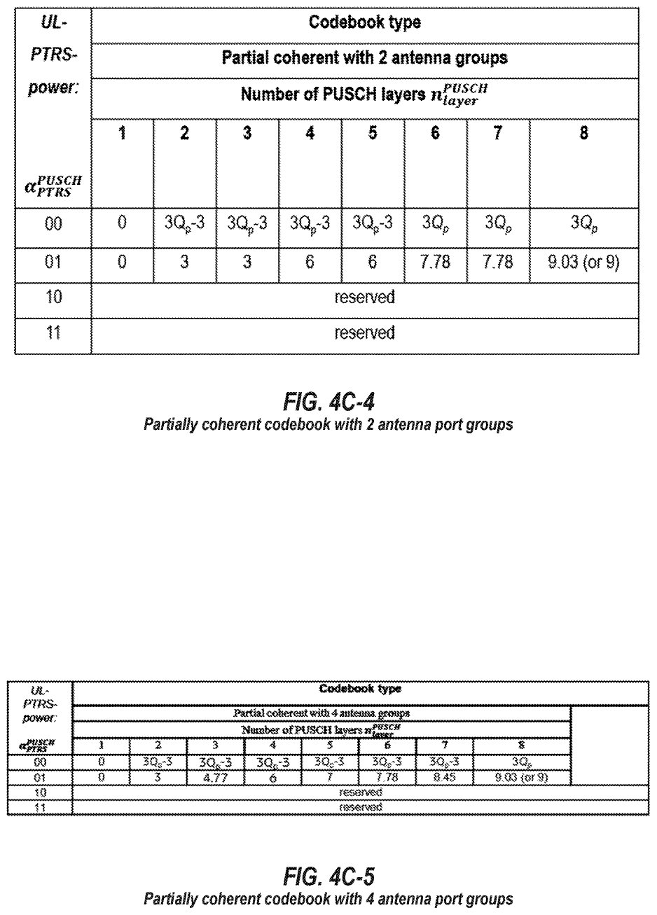

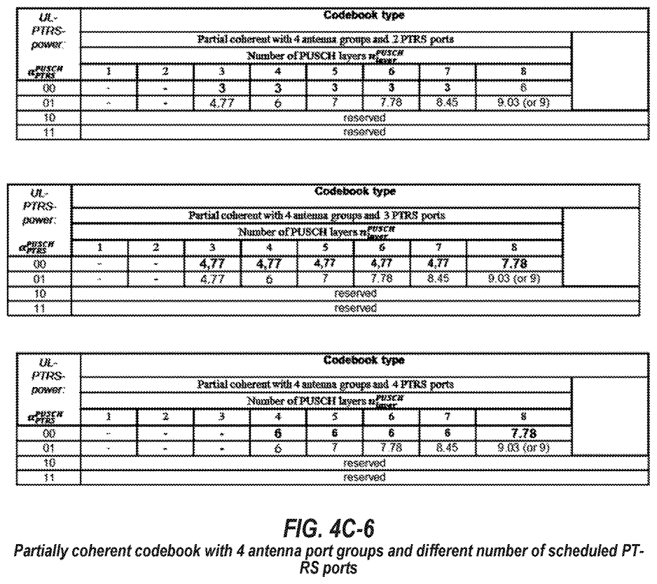

According to some embodiments of the current disclosure a method is provided for determining PT-RS to PDSCH or PUSCH power ratio per layer per RE, the method comprising:
Defining PT-RS to PDSCH power ratio per layer per RE for PDSCH scheduled with 7 and 8 layers according to the table shown in FIG. 4A-1
For partially coherent codebook, the PT-RS to PUSCH power ratio per layer per RE can be PT-RS port specific or can be common to all PT-RS ports.
   In case of PT-RS port specific, for each PT-RS port, the ratio is determined by both the number of scheduled PUSCH layers associated to the PT-RS port and the total number of scheduled PT-RS ports associated to the PUSCH (see FIG. 4C-1).
   In case of PT-RS port common, the ratio for a given number of scheduled PUSCH layers can be determined based a predefined table for a given number of antenna port groups and/or a given number of scheduled PT-RS ports (see FIGS. 4C-2, 4C-4, 4C-5).
For full coherent codebook, the PT-RS to PUSCH power ratio per layer per RE is determined by the number of scheduled PUSCH layers (see FIG. 4A-2).
For non-coherent codebook, the PT-RS to PUSCH power ratio per layer per RE is determined by the number of scheduled PT (see FIG. 4A-4).

Communication systems and devices adapted to perform one or a combination of these steps are also provided, according to some embodiments of the current disclosure.

Certain embodiments may provide one or more of the following technical advantage(s): The method enables phase tracking with PT-RS for PDSCH or PUSCH with up to eight layers by allocating proper sub-carrier offsets and PT-RS to PDSCH or PUSCH power ratios in those scenarios.

Some of the embodiments contemplated herein will now be described more fully with reference to the accompanying drawings. Embodiments are provided by way of example to convey the scope of the subject matter to those skilled in the art.

When the number of DMRS ports is increased by applying length 4 Frequency Domain Orthogonal Cover Codes (FD-OCC) codes in each of the legacy Rel-15 DMRS Code Division Multiplexing (CDM) groups and the DMRS ports are arrange according to FIG. 2C and FIG. 2D, then the associated eight single-symbol type 1 DMRS ports are ports {0,1,2,3,8,9,10,11} and the associated twelve single-symbol type 2 DMRS ports are ports {0,1,2,3,4,5,12,13,14,15,16,17) in uplink (UL). Similarly, the associated single-symbol type 1 DMRS ports in downlink (DL) are ports 1000+ {0,1,2,3,8,9,10,11}, and the associated type 2 DMRS ports are ports 1000+ {0,1,2,3,4,5,12, 13, 14, 15,16,17}. These DMRS port indices are used as an example in the following discussion. Other ways of indexing the DMRS ports are also possible.

### PT-RS Sub-Carrier Offsets

It is assumed that a UL PT-RS port can be associated to one of the eight type 1 DMRS ports {0,1,2,3,8,9,10,11} for PUSCH and a DL PT-RS port can be associated to one of the eight type 1 DMRS ports 1000+ {0,1,2,3,8,9,10,11} for PDSCH.

In one embodiment, a UL PT-RS port can be associated to one of the twelve type 2 DMRS ports {0,1,2,3,4,5,12,13,14,15,16,17) for PUSCH and a DL PT-RS port can be associated to one of the twelve type 2 DMRS ports 1000+ {0,1,2,3,4,5,12,13,14,15,16,17} for PDSCH.

In one embodiment, the sub-carrier offset,

$${k}_{ref}^{RE} ,$$

for a PT-RS associated to a DMRS port can be allocated as shown in FIG. 2E for DL PT-RS and FIG. 2F for UL PT-RS, where for rows with p=1000 to p=1005 in FIG. 2E and rows with p=0 to p=5, the legacy tables (i.e., Table 7.4.1.2.2-1 in 3GPP TS 38.211 for DL and Table 6.4.1.2.2.1-1 in 3GPP TS 38.211 for UL) are reused. In another embodiment, a subset of the columns may be included in the specification. For example, only offset=00 may be included for type 2 DMRS.

In one embodiment, new PTRS sub-carrier offset tables are introduced in NR for Rel-18 DMRS (one for DL and/or one for UL), where some of the legacy entries (i.e. rows for ports 1000 to 1005 in FIG. 2E and rows for ports 0 to 5 in FIG. 2F) are also updated, i.e. some of the entries for DMRS antenna ports 1000-1005 (FIG. 2E) or 0-5 (FIG. 2F) in the tables shown in FIG. 2E and FIG. 2F may be changed relative to the values shown in FIG. 2E and FIG. 2F.

The allocation in FIG. 2E and FIG. 2F ensures that for a same resourceElementOffset configuration, i.e., one of the four configurations: offset 00, offset 01, offset 10, offset11, PT-RS ports associated to different DMRS ports are allocated in different subcarriers. This would prevent collision of PT-RS ports scheduled in the same RB. For example, when eight UEs are co-scheduled in the same RBs for MU-MIMO and a single layer is scheduled for each UE, different DMRS ports would be scheduled for different UEs. In case of type 1 DMRS, all eight DMRS ports (i.e., ports 1000 to 1003 and 1008 to 10011 for PDSCH, and ports 0 to 3 and 8 to 11 for PUSCH) would be allocated. If PT-RS are also configured for all the UEs and all the PT-RS ports happen to be allocated in the same RBs, then the PT-RS ports cannot overlap and have to be allocated in different REs (i.e., with different sub-carrier offsets). With the sub-carrier offset allocations in FIG. 2E and FIG. 2F, the PT-RS associated with different DMRS ports are always allocated to different sub-carriers.

### Orphan RBs for Type 1 DMRS:

When Rel-18 DM-RS enhanced configuration type 1 is configured, the number of REs per CDM group over a scheduled bandwidth may not be an integer multiple of the length of the FD-OCC code (i.e., there are 6 REs per CDM group per RB for configuration type 1 and the length of the FD-OCC code is 4). This is called “orphan REs.” For example, this occurs when an odd number of consecutive RBs are scheduled or when an odd number of PRB offset of scheduled PDSCH from the point A (CRB0) is scheduled. One possible solution is to apply a scheduling restriction such that the number of consecutively scheduled PRBs and the PRB offset from CRB0 of scheduled PDSCH are even. However, in Rel-18, there is a UE capability for the case when such scheduling restriction does not have to apply. That is, when the UE indicates this capability, the UE can be scheduled such that the number of consecutively scheduled PRBs is odd. How to implement DMRS channel estimation in this case, however, is up to UE implementation. In one embodiment, for downlink PT-RS, only the sub-carrier offsets in the range 0-7 are allowed when the UE indicates this capability and the UE can be scheduled with an odd number of consecutively PRBs. This means, the following combinations referring to FIG. 2E and FIG. 2F are allowed:
for offset00, all combinations with ports 1000-1003 and 1008-1011 are allowed in FIG. 2E;
for offset01, combinations with ports 1000-1003, 1008 and 1010 are allowed in FIG. 2E;
for offset10, combinations with ports 1000, 1002, 1009, and 1011 are allowed in FIG. 2E;
for offset11, combinations with ports 1008-1011 are allowed in FIG. 2E;
for offset00, all combinations with ports 0-3 and 8-11 are allowed in FIG. 2F;
for offset01, combinations with ports 0-3, 8 and 10 are allowed in FIG. 2F;
for offset10, combinations with ports 0, 2, 9, and 11 are allowed in FIG. 2F;
for offset11, combinations with ports 8-11 are allowed in FIG. 2F.

In one embodiment, when the number of consecutively scheduled PRBs is odd or PRB offset of scheduled PDSCH from CRB0 is odd in the downlink, and when a combination that is not allowed (i.e., a combination that is not listed above) is signaled to the UE, the UE assumes that PT-RS is not present in one or more PRBs. In one variant of the embodiment, when a combination that is not allowed is signaled to the UE, the UE assumes the PT-RS is not present in the last PRB (e.g., PRB with the highest PRB index) among each set of consecutively scheduled PRBs and assumes the PT-RS is present in the remaining PRBs. In another variant of the embodiment, when a combination that is not allowed is signaled to the UE, the UE assumes the PT-RS is not present in the first PRB (e.g., PRB with the lowest PRB index) among each set of consecutively scheduled PRBs and assumes the PT-RS is present in the remaining PRBs. In yet another variant of the embodiment, the UE assumes PT-RS is not present in the RB associated with orphan REs.

In another embodiment, when the number of consecutively scheduled PRBs or PRB offset of scheduled PUSCH from CRB0 is odd in the uplink, and when a combination that is not allowed (i.e., a combination that is not listed above) is signaled to the UE, the UE does not transmit PT-RS in one or more PRBs. In one variant of this embodiment, when a combination that is not allowed is signaled to the UE, the UE does not transmit PT-RS in the last PRB (e.g., PRB with the highest PRB index) among each set of consecutively scheduled PRBs and transmits PT-RS in the remaining PRBs. In another variant of the embodiment, when a combination that is not allowed is signaled to the UE, the UE does not transmit PT-RS in the first PRB (e.g., PRB with the lowest PRB index) among each set of consecutively scheduled PRBs and transmits PT-RS in the remaining PRBs.

FIG. 3A shows an example corresponding to the allowed combination of ‘offset01’ and DMRS antenna port \tilde{p}=3 in which case the sub-carrier offset is

$${k}_{ref}^{RE} = 5.$$

In one embodiment, the parameter “resourceElementOffset” as defined in PTRS-DownlinkConfig information element and PTRS-UplinkConfig information element in 3GPP TS 38.331 used for Rel-15 DMRS is re-used also for Rel-18 extended DMRS. One benefit with this solution is that the amount of Radio Resource Control (RRC) signalling is reduced if a UE is configured with both Rel-15 and Rel-18 DMRS compared to introducing a new dedicated parameter for Rel-18 DMRS PTRS offset allocation.

In one embodiment, as illustrated in FIG. 3B and FIG. 3C, a new dedicated parameter, here referred to as “resourceElementOffset-Rel18” is introduced in PTRS-DownlinkConfig information element and/or PTRS-UplinkConfig information element in 3GPP TS 38.331. One benefit with this solution is that different PTRS mappings can be used for Rel-15 and Rel-18 DMRS (for example offset00 is used for the Rel-15 DMRS, and offset10 is used for Rel-18 DMRS), which could be useful for example if dynamic switching between Rel-15 and Rel-18 DMRS is supported, since the NR base station (gNB) can then dynamically update the PTRS frequency allocation by switching between Rel-15 and Rel-18 DMRS (this could be useful for example in case the network notice poor performance of a PTRS in UL, which might be due to colliding PTRS from the another UE in the same or different cell, and then the network can test to switch PTRS allocation by switching from Rel-15 DMRS to Rel-18 DMRS, or vice versa). In some embodiments, the frequency density of PTRS may be different for Rel-15 and Rel-18 DMRS configurations. In one embodiment, a different frequency density is configured for Rel-18 DMRS compared to the one configured for Rel-15 DMRS. The newly configured frequency density can be referred to as ‘frequencyDensity-r18’ and this new field may be introduced in PTRS-DownlinkConfig information element and/or PTRS-UplinkConfig information element in TS 38.331. This is beneficial if dynamic switching between Rel-15 and Rel-18 DMRS is supported where the gNB can then dynamically update the PTRS frequency density by switching between Rel-15 and Rel-18 DMRS.

In some other embodiments, the time density of PTRS may be different for Rel-15 and Rel-18 DMRS configurations. In one embodiment, a different time density is configured for Rel-18 DMRS compared to the one configured for Rel-15 DMRS. The newly configured time density can be referred to as ‘timeDensity-r18’ and this new field may be introduced in PTRS-DownlinkConfig information element and/or PTRS-UplinkConfig information element in TS 38.331. This is beneficial if dynamic switching between Rel-15 and Rel-18 DMRS is supported where the gNB can then dynamically update the PTRS time density by switching between Rel-15 and Rel-18 DMRS.

### PT-RS Power Boosting

In NR Releases 15 to 17, the maximum number of PDSCH layers supported when PT-RS is configured is four for type 1 DMRS and six for type 2 DMRS. The maximum number of PUSCH layers is four. In one embodiment, for the new Rel-18 DMRS ports, up to eight layers can be supported for PDSCH or PUSCH when PT-RS is configured. The transmit power of a PT-RS port can be boosted relative to the corresponding PDSCH or PUSCH transmit power per RE per layer according to the number of layers of the PDSCH or PUSCH associated to the PT-RS port.

In one embodiment, the PT-RS to PDSCH transmit power ratio per layer per RE ρ_{PTRS} is given in FIG. 4A-1 where for one to six layers the legacy ratios can be reused while for seven and eight layers, 8.45 dB (i.e., 10 log 10(7)) and 9.03 dB (i.e., 10 log 10(8), please note that 9.03 might be rounded down to 9 in the specification) can be boosted, respectively, for the associated PT-RS port. Note that a different epre-Ratio value may be used than epre-Ratio=0 as indicated in the table in FIG. 4A-1 for indicating seven and eight layers.

For PUSCH transmission up to 8 layers with up to 8 Tx antenna ports, the Tx antenna ports may be full coherent, partially coherent, or non-coherent. A corresponding full coherent, partially coherent, or non-coherent codebook can be designed accordingly. Each PUSCH layer is associated with a DMRS port. A PT-RS port may be associated to one or more of the PUSCH layers or DMRS ports.

In case of full coherent codebook, a PUSCH layer can be transmitted over all the antenna ports via a precoder w=[w(1), . . . , w(N_{Tx})]^{T}, w(i)≠0, i=1, . . . , N_{Tx}, where N_{Tx} is the number of Tx antennas. Multiple layers share the total transmit power across all the antenna ports. For

$${n}_{layer}^{PUSCH} ( {n}_{layer}^{PUSCH} ∈ [ 1 , 2 , ... , 8 ] )$$

scheduled PUSCH layers, each PUSCH layer is transmitted with

$$1 / {n}_{layer}^{PUSCH}$$

of the total transmit power, i.e.,

$${w}^{H} w = 1 / {n}_{layer}^{PUSCH} .$$

If a PT-RS is configured, it is associated to one of the DMRS ports and precoded in the same way as the associated DMRS port (or the associated PUSCH layer). The PT-RS to PUSCH power ratio per layer per RE is given by

$${α}_{PTRS}^{PUSCH} = 10 log 10 ( {n}_{layer}^{PUSCH} ) ( dB ) ,$$

i.e., the PT-RS port can use all the available power across all the antenna ports while each PUSCH layer uses only a fraction of the total power This is illustrated in FIG. 4A-2, where “xx” means a codepoint in the higher layer parameter “UL-PTRS-power” indicating a row in the table. When the codepoint “xx” is configured for “UL-PTRS-power”, a UE determines the PT-RS transmit power according to the table shown in FIG. 4A-2.

In case of non-coherent codebook, each PUSCH layer is transmitted on only one of the antenna ports. The same is also true for PT-RS port. For each PT-RS antenna port, the REs allocated to the other PT-RS ports are not used (i.e., nothing is transmitted from the antenna port) and, thus, the power normally allocated to those REs can be used for the PT-RS port to boost its transmit power. An example is illustrated in FIG. 4A-3, where two PT-RS ports are scheduled and 3 dB power boosting can be achieved for each of the PT-RS ports. Therefore, for non-coherent codebook the PT-RS to PUSCH power ratio per layer per RE is solely determined by the number of PT-RS ports associated to a PUSCH, i.e.,

$${α}_{P T R S}^{P U S C H} = 10 log 10 ( {Q}_{p} ) ( dB ) .$$

In this case, the PT-RS to PUSCH power ratio per layer per RE is the same for all PT-RS ports. This is illustrated in FIG. 4A-4.

In case of partially coherent codebook, the N_{Tx} antenna ports can be divided into multiple antenna port groups, where antenna ports within each port group are coherent and antenna ports in different antenna port groups are non-coherent. Each port group can be associated with a PT-RS port. An example of N_{Tx}=8 and 2 antenna port groups is shown in FIG. 4B-1, where antenna ports 1 to 4 form the 1st port group and antenna ports 5 to 8 form the 2nd port group. In one embodiment, each PUSCH layer is transmitted on all antenna ports in one of the two antenna port groups. When a PUSCH layer is transmitted in port group 1, the precoder is in the form of w=[w(1), . . . , w(4), 0, . . . , 0]^{T}, where w(i)+0 for i=1, . . . , 4 and w(i)=0 for i=5, . . . , 8. Similarly, when a PUSCH layer is transmitted in port group 2, the corresponding precoder is in the form of w=[0, . . . , 0, w(5), w(6), w(7), w(8)]^{T}, where w(i)=0 for i=1, . . . , 4 and w(i)≠0 for i=5, . . . , 8. In each antenna port group, up to four PUSH layers can be transmitted, and each layer is allocated with 1/r of total transmit power available in the antenna port group, i.e.,

$${w}^{H} w = \frac{1}{2 r} ,$$

where r is the number layers in a port group. It is assumed here that the available power in each port group is ½ of total transmit power over all antennas. Each port group is associated to a PT-RS port and a maximum of two PT-RS ports are needed.

The above can be extended to 4 antenna groups, an example is shown in FIG. 4B-2. In this case, a PUSCH layer is transmitted on all antenna ports in one of the four antenna port groups. For example, when a PUSCH layer is transmitted in port group 1, the precoder is in the form of w=[w(1), . . . , w(2), 0, . . . , 0]^{T}, where w(i)≠0 for i=1,2 and w(i)=0, for i=3, . . . , 8. Similarly, when a PUSCH layer is transmitted in port group 2, the corresponding precoder is in the form of w=[0,0, w(3), w(4), 0, . . . , 0)]^{T}, where w(i)=0 for i=1,2,5,6,7,8 and w(i)≠0, for i=3,4. In each antenna port group, up to two PUSH layers can be scheduled or transmitted, and each layer is allocated with 1/r of total transmit power in the antenna port group, i.e.,

$${w}^{H} w = \frac{1}{4 r} ,$$

where r is the number layers scheduled in a port group. It is assumed here that the available power in each port group is ¼ of total transmit power over all antennas. Each port group is associated to a PT-RS port and a maximum of 4 PT-RS ports are needed.

### PT-RS Port Specific PT-RS Power Boosting:

In one embodiment, for each PT-RS port, the PT-RS to PUSCH transmit power ratio per layer per RE is determined by the associated number of scheduled PUSCH layers in the same port group, i.e.,

$${α}_{P TRS , k}^{P U S C H} ( dB ) = 10 log 10 ( {n}_{l a yer , k}^{P U S C H} {Q}_{p} ) , where {n}_{layer , k}^{P U S C H}$$

is the number of scheduled PUSCH layers in the antenna port group associated to PTRS port k (k=0,1, . . . , Qₚ−1) and Qₚ is the total number of scheduled PT-RS ports across the antenna port groups. For different PT-RS ports,

$${α}_{PTRS , k}^{P U S C H} ( dB )$$

can be the same or different, depending on whether the same or different number of PUSCH layers are scheduled in the corresponding antenna port groups. For example, assuming PT-RS port 0 is associated to antenna port group 1 and PT-RS port 1 is associated with antenna port group 2 in the previous example with 8 antenna ports, if 2 layers are scheduled in port group 1 and 3 layers are scheduled in port group 2, then Qₚ=2, and for PT-RS port 0,

$${α}_{P TRS , 0}^{P U S C H} ( dB ) = 10 log 10 ( 2 \times 2 ) = 6 ( dB )$$

and, for the PT-RS port 1,

$${α}_{P TRS , 1}^{P U S C H} ( dB ) = 10 log 10 ( 3 \times 2 ) = 7.78 ( dB ) .$$

In another example with 4 antenna port groups, assuming PT-RS ports {0,1,2,3} are associated to antenna port groups {1,2,3,4}, then if 2 layers are scheduled in port group 1 and 1 layers is scheduled in each of port groups {2,3,4}, Qₚ=4, and for PT-RS port 0,

$${α}_{P TRS , 0}^{P U S C H} ( dB ) = 10 log 10 ( 2 \times 4 ) = 9 ( dB )$$

and for the PT-RS ports

$$\{ 1 , 2 , 3 \} , {α}_{P TRS , k}^{P U S C H} ( dB ) = 10 log 10 ( 1 \times 4 ) = 6 ( dB ) .$$

In general, for N_{ant,groups} antenna groups and Qₚ (Qₚ≤N_{ant,groups}) PT-RS ports associated a scheduled PUSCH, the PT-RS to PDSCH transmit power ratio per layer per RE for a PT-RS port is determined by the number of scheduled PUSCH layers associated to the PT-RS port in the same antenna port group, i.e.,

$${α}_{PTRS , k}^{P U S C H} ( dB ) = 10 log 10 ( {n}_{l a yer , k}^{P U S C H} {Q}_{p} ) .$$

This is illustrated in FIG. 4C-1. Note that for 8 Tx antennas with 4 port groups each with two antenna ports,

$${n}_{l a yer , k}^{P U S C H} \leq 2.$$

There can be another case with a mixed partially coherent and non-coherent port groups, where in a first port group(s), a PUSCH layer is transmitted on only a single antenna port, while in a second port group(s), a PUSCH layer is transmitted on all antenna ports of one port group. In one embodiment, for a PT-RS port associated to the first port group(s), the PT-RS to PUSCH transmit power ratio per layer per RE is determined according to FIG. 4A-4 while for a PT-RS port associated to the second port group(s), the PT-RS to PUSCH transmit power ratio per layer per RE is determined according to FIG. 4A-2. For example, for 8 antenna ports with four antenna port groups and 5 PUSCH layers are scheduled as shown in FIG. 4C-2, where layers 1 and 2 are scheduled in antenna group 1 and layers 3 to 5 are scheduled in antenna group 2 to 4 with one layer per group. w1=[w₁(1), 0, . . . , 0]^{T} w2=[0 w₂(2), 0, . . . , 0]^{T}. In this case, for PT-RS port 0, its PT-RS to PUSCH transmit power ratio per layer per RE is determined according to, i.e.,

$${α}_{P TRS , 0}^{P U S C H} ( dB ) = 10 log 10 ( {Q}_{p} ) = 10 log 10 ( 4 ) = 6 dB .$$

For PT-RS ports 1 to 3, their PT-RS to PUSCH transmit power ratio per layer per RE is determined according to FIG. 4A-2, i.e.,

$${α}_{P TRS , k}^{P U S C H} ( dB ) = 10 log 10 ( {n}_{l a yer , k}^{P U S C H} {Q}_{p} ) = 10 log 10 ( 1 \times 4 ) = 6 dB ,$$

$$k = 1 , 2 , 3 …$$

Note that the PT-RS to PUSCH transmit power ratio per layer per RE for a PT-RS port discussed above represents the maximum PT-RS to PUSCH transmit power ratio per layer per RE that can be achieved. In some scenarios, the PT-RS to PUSCH transmit power ratio per layer per RE may be capped to certain value Y (dB). For example, the maximum PT-RS to PUSCH transmit power ratio per layer may be limited to Y=6 dB. In that case, if the PT-RS to PUSCH transmit power ratios in FIG. 4A-1, 4A-2, 4A-4, and 4C-1 are greater than Y, then they will be set to YdB. Alternatively, a different row in the tables in 4A-1, 4A-2, 4A-4, and 4C-1 may be used for the purpose. An example is shown in FIG. 4C-3, where a new row “yy” is used.

### Common PT-RS Power Boosting:

In some scenarios, there may be a need to have the same power boosting for all PT-RS ports. In the embodiments below, it is assumed that a same PT-RS to PUSCH EPRE power ratio per RE per layer is determined for all scheduled PT-RS ports.

In one embodiment, different entries (and/or tables) for PT-RS to PUSCH EPRE power ratio are used for 2 antenna groups and 4 antenna groups for partially coherent codebooks.

In one embodiment, different entries (and/or tables) for PT-RS to PUSCH EPRE power ratio are used depending on the number of scheduled PT-RS ports for a UE.

FIG. 4C-4 illustrates one example of a PT-RS to PUSCH EPRE power ratio table for 2 antenna groups, where the maximum number of PTRS ports are equal to 2, i.e., Qₚ∈{1,2}. Qₚ=1 when all PUSCH layers are scheduled in one antenna group and Qₚ=2 when some PUSCH layers are transmitted in one antenna group while other layers are transmitted in the other antenna group. For up to 5 PUSCH layers, there is a possibility that one layer is scheduled/transmitted in a first antenna group while the rest of layers are scheduled/transmitted in a second antenna group. For the PT-RS in the first antenna group, it would have the same power per RE per layer as the PUSCH in the same antenna group if no power is borrowed from the unused/blanked out REs associated to the PT-RS port in the second antenna group. when power is borrowed from the unused/blanked out REs associated to the PT-RS port in the second antenna group, the PT-RS to PUSCH EPRE power ratio is 3 dB or (3Qₚ−3). For PUSCH with 6 layers, at least two PUSCH layers need to be scheduled/transmitted in each of the two antenna groups. The PT-RS to PUSCH EPRE power ratio is at least 3 dB without power borrowing from the unused/blanked out REs associated to PT-RS port in the other antenna group. With power borrowing, the PT-RS to PUSCH EPRE power ratio is at least 6 dB or 3Qₚ. For 7 and 8 PUSCH layers, at least three and four PUSCH layers, respectively, need to be scheduled/transmitted in each of the two antenna groups. With power borrowing, the PT-RS to PUSCH EPRE power ratio is at least 7.78 dB (i.e., 10 log 10(6)) for 7 layers and 9.03 dB (i.e., 10 log 10(8)) for 8 layers. In the row with “UL-PTRS-power=00”, it limits the maximum PT-RS power boosting to 6 dB,

It might be so that not all possible rank combinations are allowed for 8 TX UE with 2 antenna groups in order to save PMI overhead. For example, the difference between the number of layers in one antenna group and the number of layers in the other antenna group cannot be more than one. In this case, one or more of the rank combinations: 4+1 (i.e. 4 layers for a first antenna group and 1 layer for a second antenna group), 3+1, etc., would not be supported and the PT-RS to PUSCH EPRE power ratio would be determined by the PT-RS port associated to an antenna group with a smaller number of allocated PUSCH layers, i.e.,

$${α}_{P T R S}^{P U S C H} = 10 log 10 ( {Q}_{p} min ( {n}_{l ayer , k}^{P U S C H} , k = 0 , 1 ) ) .$$

For example, in case one layer is in antenna group 1 and 2 layers in antenna group 2 for a total of 3 PUSCH layers, the PT-RS to PUSCH EPRE power ratio would be determined by the PT-RS port associated to antenna group 1, i.e.,

$${α}_{P T R S}^{P U S C H} = 10 log 10 ( {Q}_{p} min ( {n}_{layer , k}^{P U S C H} , k = 0 , 1 ) ) = 10 log 10 ( 2 \times 1 ) = 3 dB .$$

With this approach, the PT-RS to PUSCH EPRE power ratio for different number of PUSCh layers can also be determined. An example is shown in the row with “UL PTRS-power=01” in FIG. 4C-3.

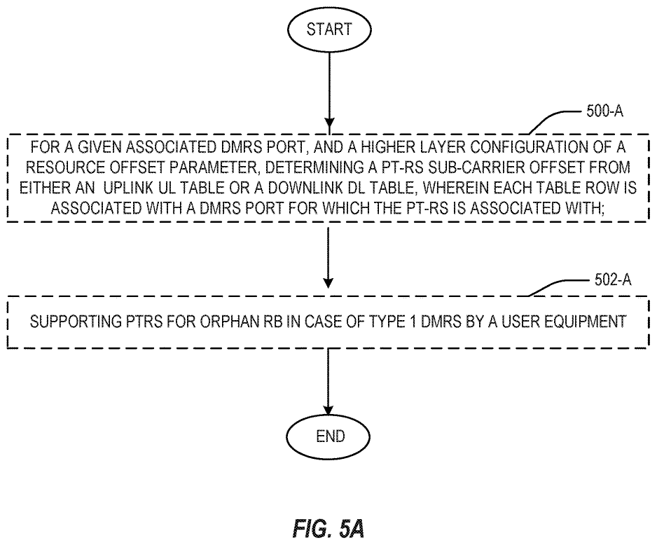

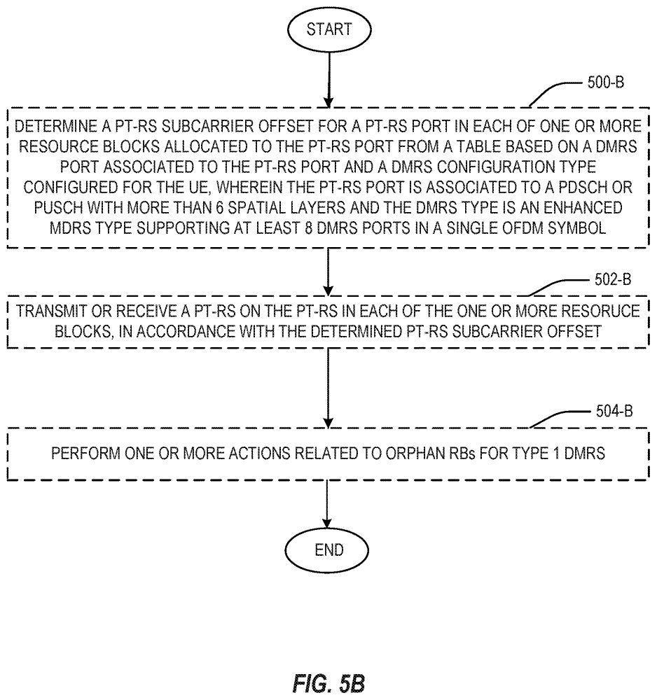

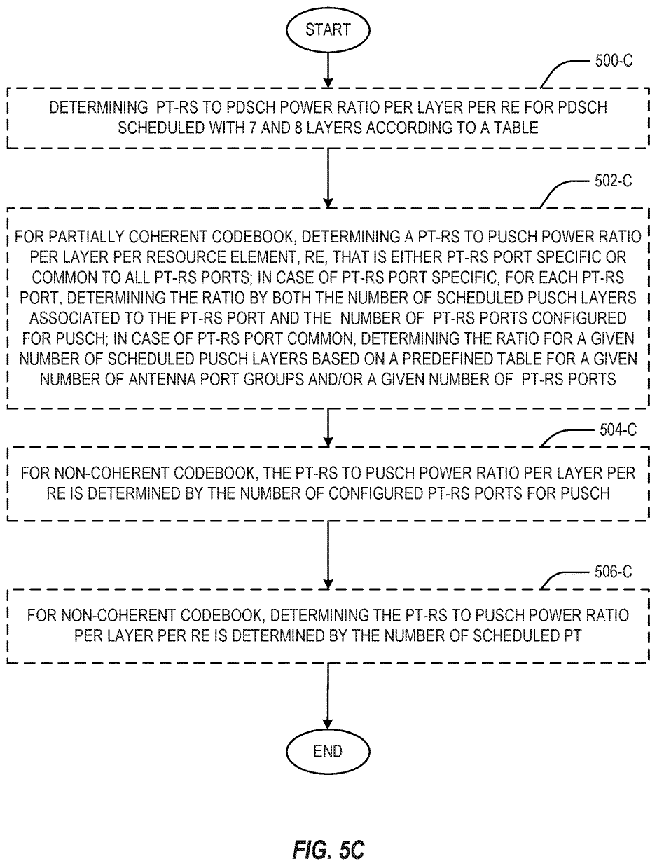

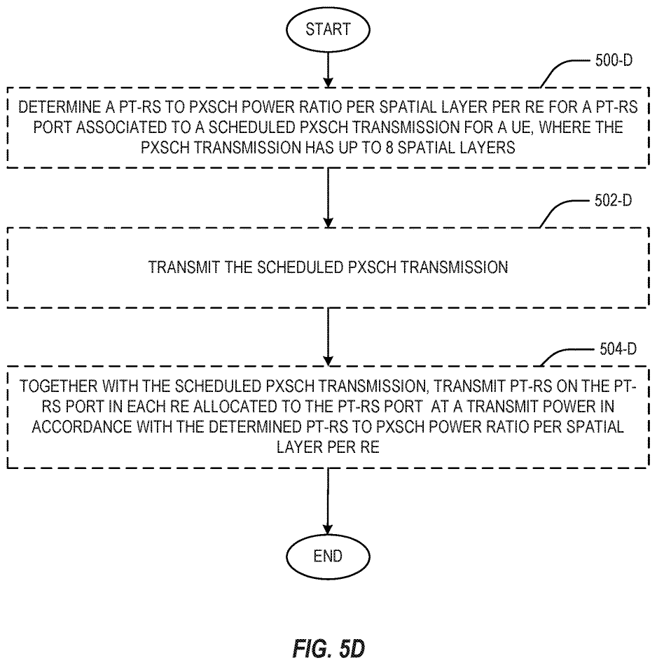

FIG. 4C-5 illustrates one example of a how one or more entries of a PT-RS to PUSCH EPRE power ratio table for an 8 TX UE with 4 antenna groups, where the maximum number of PTRS ports are equal to 2, i.e., Q_p∈{1,2} and each PT-RS port is associated with two antenna groups.

In one embodiment for a UE supporting maximum 4 PTRS and 8 TX with 4 antenna groups, different PT-RS to PUSCH EPRE power ratio tables are used for different number of scheduled PTRS Ports. One example of three such tables for 2, 3 and 4 scheduled PTRS ports respectively are shown in FIG. 4C-6.

Note that the numbers in all tables are approximate and can be rounded down or up in the specification. Note that only one or a subset of all rows and/or columns in each table might be specified (and other entries can be included in the remaining rows/columns of the tables).

FIG. 5A illustrates a method performed in a wireless communication system for allocating a subcarrier offset for a phase tracking reference signal PT-RS port in each resource block RB allocated for the PT-RS port, wherein when both PT-RS and Rel 18 DMRS ports are configured for a user equipment UE, a PT-RS port is associated with one of the 8 type 1 DMRS ports or 12 type 2 DMRS ports. The method comprising one or more of: (step 500 A) for a given associated DMRS port, and a higher layer configuration of a resource offset parameter, determining a PT-RS sub-carrier offset from either an uplink UL table or a downlink DL table, wherein each table row is associated with a DMRS port for which the PT-RS is associated with; and (step 502-A) supporting PTRS for orphan RB in case of type 1 DMRS by a user equipment. The steps can be performed in any combination and in any order.

FIG. 5B is a flow chart that illustrates the operation of a UE or network node (e.g., base station such as, e.g., a gNB) for PT-RS subcarrier offset allocation for each RB allocated for a PT-RS port, wherein both PT-RS and DMRS ports are configured for the UE, in accordance with an embodiment of the present disclosure. Here, the term “node” is used to refer to the apparatus that is performing the method, which may be either the UE or the network node. As illustrated, for each RB of one or more RBs allocated for a PT-RS port configured for the UE, the node determines a PT-RS subcarrier offset for the PT-RS port from a table (e.g., an UL table or DL table) based on a DMRS port associated to the PT-RS port and a DMRS configuration type configured for the UE, wherein the PT-RS port is associated to a PDSCH or PUSCH with more than 6 spatial layers and the DMRS type is an enhanced DMRS type supporting at least 8 DMRS ports in a single OFDM symbol (step 500-B). The DMRS port associated to the PT-RS port is one of a plurality of DMRS ports, wherein eight of the plurality of DMRS ports are associated to a first DMRS configuration type and twelve of the plurality of DMRS ports are associated to a second DMRS configuration type. Further, each row of the table is associated with one of plurality of DMRS ports and defines different PT-RS subcarrier offsets for a PT-RS port associated to the one of the plurality of DMRS ports for different resource element offset parameter values for at least one of the first DMRS configuration type and the second DMRS configuration type. The node transmits or receives a PT-RS on the PT-RS port in each of the one or more RBs, in accordance with the determined PT-RS subcarrier offset (step 502-B). In one embodiment, the table is an uplink table such as that of FIG. 2F, in which case PT-RS is transmitted by the UE on the uplink and received by the network node. In another embodiment, the table is a downlink table such as that of FIG. 2E, in which case PT-RS is transmitted by the network node on the downlink and received by the UE. In addition, the node may perform one or more actions related to orphan RBs for Type 1 DMRS (step 504-B). Details of such actions are described above, and therefore not repeated here.

FIG. 5C illustrates a method in a wireless communication system for determining phased tracking reference signal PT-RS to physical downlink shared channel PDSCH or physical uplink shared channel PUSCH power ratio per layer per resource element RE, wherein both PT-RS and Rel 18 DMRS ports are configured for a UE, and a PDSCH or PUSCH is scheduled with up to 8 layers. The method includes one or more of determining (500-C) PT-RS to PDSCH power ratio per layer per RE for PDSCH scheduled with 7 and 8 layers according to a table; for partially coherent codebook, determining (502-C) a PT-RS to PUSCH power ratio per layer per RE that is either PT-RS port specific or common to all PT-RS ports; in case of PT-RS port specific, for each PT-RS port, determining the ratio by both the number of scheduled PUSCH layers associated to the PT-RS port and the total number of scheduled PT-RS ports configured for PUSCH; in case of PT-RS port common, determining the ratio for a given number of scheduled PUSCH layers based on a predefined table for a given number of antenna port groups and/or a given number of scheduled PT-RS ports; for full coherent codebook, determining (504-C) the PT-RS to PUSCH power ratio per layer per RE by the number of scheduled PUSCH layers; and/or for non-coherent codebook, determining (506-C) the PT-RS to PUSCH power ratio per layer per RE is determined by the configured PT-RS ports for PUSCH. The steps can be performed in any combination and in any order.

FIG. 5D illustrates the operation of a transmitting node (i.e., a UE in the case of uplink or a network node (e.g., a base station or gNB) in the case of downlink) in accordance with one embodiment of the present disclosure. The transmitting node determines a PT-RS to PxSCH power ratio per spatial layer per RE for a PT-RS port associated to a scheduled PxSCH transmission for a UE, where the PxSCH transmission has up to 8 spatial layers (step 500-D). Note that, as used herein, “PxSCH” is a general term that refers to either PDSCH or PUSCH. The transmitting node determines the PT-RS to PxSCH power ratio per spatial layer per RE for the PT-RS port associated to the scheduled PxSCH transmission in accordance with any of the embodiments for doing so described above. The transmitting node transmits the scheduled PxSCH transmission (step 502-D) and, together with the scheduled PxSCH transmission, also transmits PT-RS on the PT-RS port in each RE allocated to the PT-RS port at a transmit power in accordance with the determined PT-RS to PxSCH power ratio per spatial layer per RE (step 504-D).

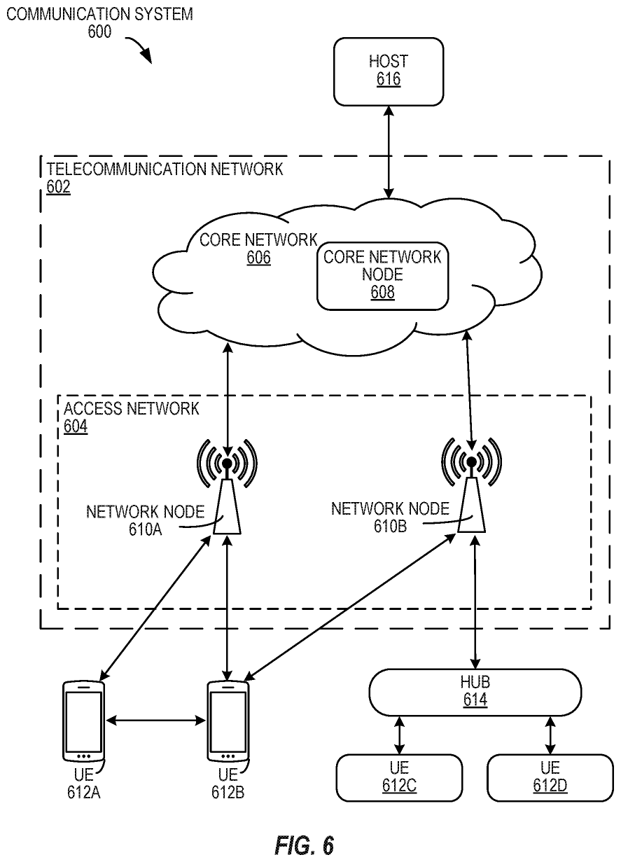

FIG. 6 shows an example of a communication system 600 in accordance with some embodiments.

In the example, the communication system 600 includes a telecommunication network 602 that includes an access network 604, such as a Radio Access Network (RAN), and a core network 606, which includes one or more core network nodes 608. The access network 604 includes one or more access network nodes, such as network nodes 610A and 610B (one or more of which may be generally referred to as network nodes 610), or any other similar Third Generation Partnership Project (3GPP) access node or non-3GPP Access Point (AP). The network nodes 610 facilitate direct or indirect connection of User Equipment (UE), such as by connecting UEs 612A, 612B, 612C, and 612D (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602 and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system 600 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 602 is a cellular network that implements 3GPP standardized features. Accordingly, the telecommunication network 602 may support network slicing to provide different logical networks to different devices that are connected to the telecommunication network 602. For example, the telecommunication network 602 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 614 communicates with the access network 604 to facilitate indirect communication between one or more UEs (e.g., UE 612C and/or 612D) and network nodes (e.g., network node 610B). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a Virtual Reality (VR) headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610B. The hub 614 may also allow for a different communication scheme and/or schedule between the hub 614 and UEs (e.g., UE 612C and/or 612D), and between the hub 614 and the core network 606. In other examples, the hub 614 is connected to the core network 606 and/or one or more UEs via a wired connection. Moreover, the hub 614 may be configured to connect to a Machine-to-Machine (M2M) service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610B. In other embodiments, the hub 614 may be a non-dedicated hub—that is, a device which is capable of operating to route communications between the UEs and the network node 610B, but which is additionally capable of operating as a communication start and/or end point for certain data channels.

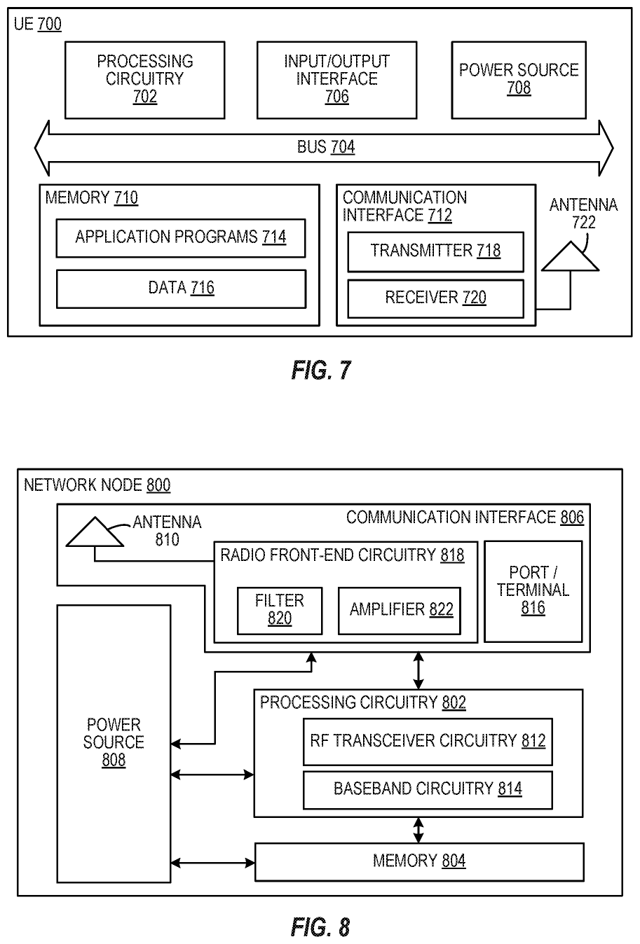

FIG. 7 shows a UE 700 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 702 may include multiple Central Processing Units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging the power source 708. Power circuitry may perform any formatting, converting, or other modification to the power from the power source 708 to make the power suitable for the respective components of the UE 700 to which power is supplied.

The memory 710 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 710 may allow the UE 700 to access instructions, application programs, and the like stored on transitory or non-transitory memory media, to off-load data, or to upload data. An article of manufacture, such as one utilizing a communication system, may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., the antenna 722) and may share circuit components, software, or firmware, or alternatively be implemented separately.

In the illustrated embodiment, communication functions of the communication interface 712 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 712, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 8 shows a network node 800 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes processing circuitry 802, memory 804, a communication interface 806, and a power source 808. The network node 800 may be composed of multiple physically separate components (e.g., a Node B component and an RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 800 may be configured to support multiple RATs. In such embodiments, some components may be duplicated (e.g., separate memory 804 for different RATs) and some components may be reused (e.g., an antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 800.

The processing circuitry 802 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 800 components, such as the memory 804, to provide network node 800 functionality.

In some embodiments, the processing circuitry 802 includes a System on a Chip (SOC). In some embodiments, the processing circuitry 802 includes one or more of Radio Frequency (RF) transceiver circuitry 812 and baseband processing circuitry 814. In some embodiments, the RF transceiver circuitry 812 and the baseband processing circuitry 814 may be on separate chips (or sets of chips), boards, or units, such as radio units and digital units. In alternative embodiments, part or all of the RF transceiver circuitry 812 and the baseband processing circuitry 814 may be on the same chip or set of chips, boards, or units.

The memory 804 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and the memory 804 are integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. The radio front-end circuitry 818 comprises filters 820 and amplifiers 822. The radio front-end circuitry 818 may be connected to the antenna 810 and the processing circuitry 802. The radio front-end circuitry 818 may be configured to condition signals communicated between the antenna 810 and the processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of the filters 820 and/or the amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface 806 may comprise different components and/or different combinations of components.

In certain alternative embodiments, the network node 800 does not include separate radio front-end circuitry 818; instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes the one or more ports or terminals 816, the radio front-end circuitry 818, and the RF transceiver circuitry 812 as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, the communication interface 806, and/or the processing circuitry 802 may be configured to perform any receiving operations and/or certain obtaining operations described herein as being performed by the network node 800. Any information, data, and/or signals may be received from a UE, another network node, and/or any other network equipment. Similarly, the antenna 810, the communication interface 806, and/or the processing circuitry 802 may be configured to perform any transmitting operations described herein as being performed by the network node 800. Any information, data, and/or signals may be transmitted to a UE, another network node, and/or any other network equipment.

The power source 808 provides power to the various components of the network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid or an electricity outlet) via input circuitry or an interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

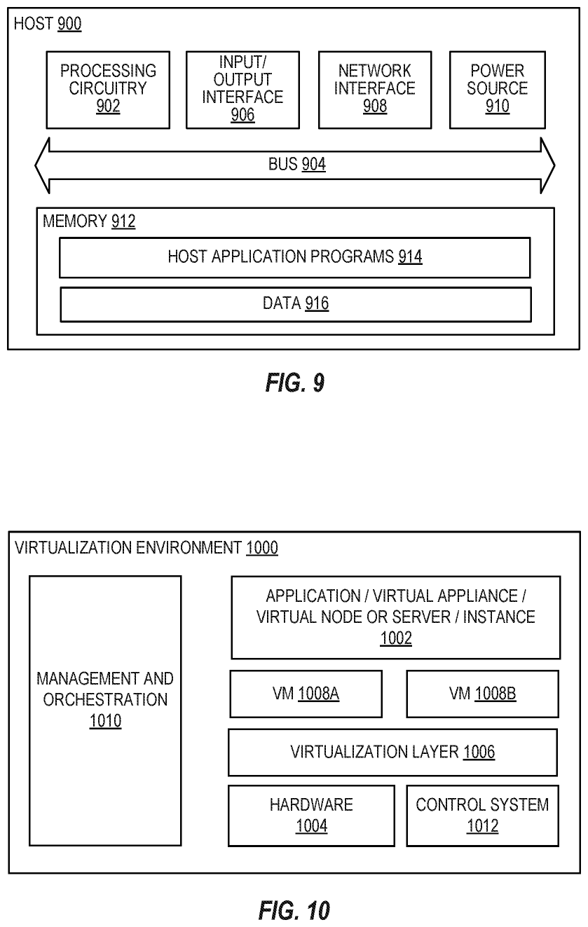

FIG. 9 is a block diagram of a host 900, which may be an embodiment of the host 616 of FIG. 6, in accordance with various aspects described herein. As used herein, the host 900 may be or comprise various combinations of hardware and/or software including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and memory 912. Other components may be included in other embodiments. Features of these components may be substantially similar to those described with respect to the devices of previous figures, such as FIGS. 7 and 8, such that the descriptions thereof are generally applicable to the corresponding components of the host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 914 may also provide for user authentication and licensing checks and may periodically report health, routes, and content availability to a central node, such as a device in or on the edge of a core network. Accordingly, the host 900 may select and/or indicate a different host for Over-The-Top (OTT) services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in the virtualization environment 900 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or VM Monitors (VMMs)), provide VMs 1008A and 1008B (one or more of which may be generally referred to as VMs 1008), and/or perform any of the functions, features, and/or benefits described in relation with some embodiments described herein. The virtualization layer 1006 may present a virtual operating platform that appears like networking hardware to the VMs 1008.

The VMs 1008 comprise virtual processing, virtual memory, virtual networking, or interface and virtual storage, and may be run by a corresponding virtualization layer 1006. Different embodiments of the instance of a virtual appliance 1002 may be implemented on one or more of the VMs 1008, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1008 may be a software implementation of a physical machine that runs programs as if they were executing on a physical, non-virtualized machine. Each of the VMs 1008, and that part of the hardware 1004 that executes that VM, be it hardware dedicated to that VM and/or hardware shared by that VM with others of the VMs 1008, forms separate virtual network elements. Still in the context of NFV, a virtual network function is responsible for handling specific network functions that run in one or more VMs 1008 on top of the hardware 1004 and corresponds to the application 1002.

The hardware 1004 may be implemented in a standalone network node with generic or specific components. The hardware 1004 may implement some functions via virtualization. Alternatively, the hardware 1004 may be part of a larger cluster of hardware (e.g., such as in a data center or CPE) where many hardware nodes work together and are managed via management and orchestration 1010, which, among others, oversees lifecycle management of the applications 1002. In some embodiments, the hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1012 which may alternatively be used for communication between hardware nodes and radio units.

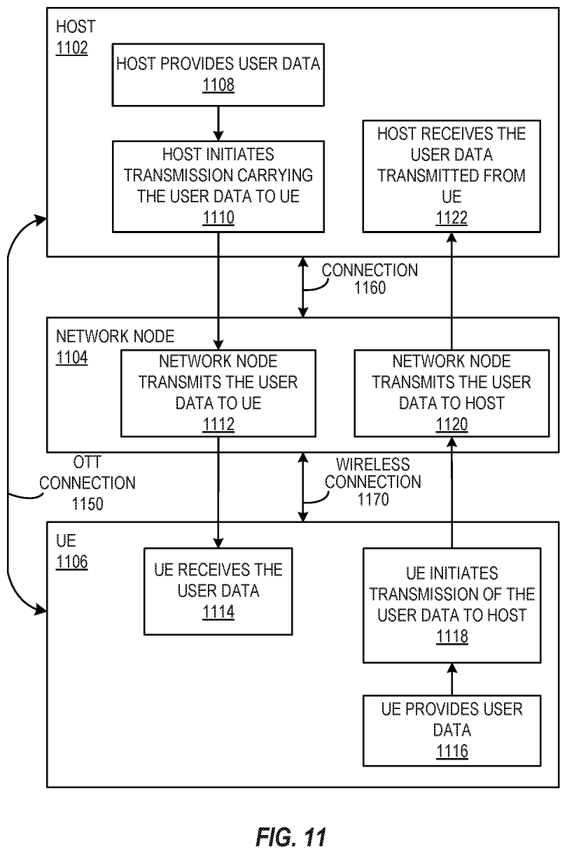

FIG. 11 shows a communication diagram of a host 1102 communicating via a network node 1104 with a UE 1106 over a partially wireless connection in accordance with some embodiments. Example implementations, in accordance with various embodiments, of the UE (such as the UE 612A of FIG. 6 and/or the UE 700 of FIG. 7), the network node (such as the network node 610A of FIG. 6 and/or the network node 800 of FIG. 8), and the host (such as the host 616 of FIG. 6 and/or the host 900 of FIG. 9) discussed in the preceding paragraphs will now be described with reference to FIG. 11.

Like the host 900, embodiments of the host 1102 include hardware, such as a communication interface, processing circuitry, and memory. The host 1102 also includes software, which is stored in or is accessible by the host 1102 and executable by the processing circuitry. The software includes a host application that may be operable to provide a service to a remote user, such as the UE 1106 connecting via an OTT connection 1150 extending between the UE 1106 and the host 1102. In providing the service to the remote user, a host application may provide user data which is transmitted using the OTT connection 1150.

The network node 1104 includes hardware enabling it to communicate with the host 1102 and the UE 1106 via a connection 1160. The connection 1160 may be direct or pass through a core network (like the core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by the UE 1106 and executable by the UE's processing circuitry. The software includes a client application, such as a web browser or operator-specific “app” that may be operable to provide a service to a human or non-human user via the UE 1106 with the support of the host 1102. In the host 1102, an executing host application may communicate with the executing client application via the OTT connection 1150 terminating at the UE 1106 and the host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via the connection 1160 between the host 1102 and the network node 1104 and via a wireless connection 1170 between the network node 1104 and the UE 1106 to provide the connection between the host 1102 and the UE 1106. The connection 1160 and the wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104 in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR, or AR which it can broadcast, multicast, or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1150 between the host 1102 and the UE 1106 in response to variations in the measurement results. The measurement procedure and/or the network functionality for reconfiguring the OTT connection 1150 may be implemented in software and hardware of the host 1102 and/or the UE 1106. In some embodiments, sensors (not shown) may be deployed in or in association with other devices through which the OTT connection 1150 passes; the sensors may participate in the measurement procedure by supplying values of the monitored quantities exemplified above, or by supplying values of other physical quantities from which software may compute or estimate the monitored quantities. The reconfiguring of the OTT connection 1150 may include message format, retransmission settings, preferred routing, etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency, and the like by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole and/or by end users and a wireless network generally.

Some example embodiments of the present disclosure are as follows:

### Group A Embodiments

Embodiment 1: A method in a wireless communication system for allocating a subcarrier offset for a phase tracking reference signal PT-RS port in each resource block RB allocated for the PT-RS port, wherein when both PT-RS and Rel 18 DMRS ports are configured for a user equipment UE, a PT-RS port is associated with one of the 8 type 1 DMRS ports or 12 type 2 DMRS ports the method comprising one or more of:
for a given associated DMRS port, and a higher layer configuration of a resource offset parameter, determining (500-A) a PT-RS sub-carrier offset from either an uplink UL table or a downlink DL table, wherein each table row is associated with a DMRS port for which the PT-RS is associated with; and
supporting (502-A) PTRS for orphan RB in case of type 1 DMRS by a user equipment.

Embodiment 2: The method of embodiment 1, wherein the DMRS port is one of type 1 or type 2.

Embodiment 3: The method of embodiment 1, wherein the resource offset parameter is “resourceElementOffset”.

Embodiment 4: A method in a wireless communication system for determining phased tracking reference signal PT-RS to physical downlink shared channel PDSCH or physical uplink shared channel PUSCH power ratio per layer per resource element RE, wherein both PT-RS and Rel 18 DMRS ports are configured for a UE, and a PDSCH or PUSCH is scheduled with up to 8 layers, the method comprising one or more of:
determining (500-B) PT-RS to PDSCH power ratio per layer per RE for PDSCH scheduled with 7 and 8 layers according to a table;
for partially coherent codebook, determining (502-B) a PT-RS to PUSCH power ratio per layer per RE that is either PT-RS port specific or common to all PT-RS ports;
   in case of PT-RS port specific, for each PT-RS port, determining the ration by both the number of scheduled PUSCH layers associated to the PT-RS port and the total number of scheduled PT-RS ports associated to the PUSCH;
   in case of PT-RS port common, determining the ratio for a given number of scheduled PUSCH layers based on a predefined table for a given number of antenna port groups and/or a given number of scheduled PT-RS ports;
for full coherent codebook, determining (504-B) the PT-RS to PUSCH power ratio per layer per RE by the number of scheduled PUSCH layers; and/or
for non-coherent codebook, determining (506-B) the PT-RS to PUSCH power ratio per layer per RE is determined by the number of scheduled PT.

### Group B Embodiments

Embodiment 5: A method performed by a network node, the method including any of the features of Group A Embodiments.

Embodiment 6: The method of any of the previous embodiments, further comprising: obtaining user data; and forwarding the user data to a host or a user equipment.

### Group C Embodiments

Embodiment 7: A method performed by a user equipment, the method including any of the features of Group A Embodiments.

### Group D Embodiments

Embodiment 8: A user equipment, comprising: processing circuitry configured to perform any of the steps of any of the Group C embodiments; and power supply circuitry configured to supply power to the processing circuitry.

Embodiment 9: A network node, the network node comprising: processing circuitry configured to perform any of the steps of any of the Group B embodiments; and power supply circuitry configured to supply power to the processing circuitry.

Embodiment 10: A user equipment (UE), the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group C embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 11: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group V embodiments to receive the user data from the host.

Embodiment 12: The host of the previous embodiment, wherein the cellular network further includes a network node configured to communicate with the UE to transmit the user data to the UE from the host.

Embodiment 13: The host of the previous 2 embodiments, wherein: the processing circuitry of the host is configured to execute a host application, thereby providing the user data; and the host application is configured to interact with a client application executing on the UE, the client application being associated with the host application.

Embodiment 14: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group C embodiments to receive the user data from the host.

Embodiment 15: The method of the previous embodiment, further comprising: at the host, executing a host application associated with a client application executing on the UE to receive the user data from the UE.

Embodiment 16: The method of the previous embodiment, further comprising: at the host, transmitting input data to the client application executing on the UE, the input data being provided by executing the host application, wherein the user data is provided by the client application in response to the input data from the host application.

Embodiment 17: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group C embodiments to transmit the user data to the host.

Embodiment 18: The host of the previous embodiment, wherein the cellular network further includes a network node configured to communicate with the UE to transmit the user data from the UE to the host.

Embodiment 19: The host of the previous 2 embodiments, wherein: the processing circuitry of the host is configured to execute a host application, thereby providing the user data; and the host application is configured to interact with a client application executing on the UE, the client application being associated with the host application.

Embodiment 20: A method implemented by a host configured to operate in a communication system that further includes a network node and a user equipment (UE), the method comprising: at the host, receiving user data transmitted to the host via the network node by the UE, wherein the UE performs any of the steps of any of the Group C embodiments to transmit the user data to the host.

Embodiment 21: The method of the previous embodiment, further comprising: at the host, executing a host application associated with a client application executing on the UE to receive the user data from the UE.

Embodiment 22: The method of the previous embodiment, further comprising: at the host, transmitting input data to the client application executing on the UE, the input data being provided by executing the host application, wherein the user data is provided by the client application in response to the input data from the host application.

Embodiment 23: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 24: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 25: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 26: The method of the previous embodiment, further comprising, at the network node, transmitting the user data provided by the host for the UE.

Embodiment 27: The method of any of the previous 2 embodiments, wherein the user data is provided at the host by executing a host application that interacts with a client application executing on the UE, the client application being associated with the host application.

Embodiment 28: A communication system configured to provide an over-the-top service, the communication system comprising a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 29: The communication system of the previous embodiment, further comprising: the network node; and/or the user equipment.

Embodiment 30: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 31: The host of the previous 2 embodiments, wherein: the processing circuitry of the host is configured to execute a host application, thereby providing the user data;

and the host application is configured to interact with a client application executing on the UE, the client application being associated with the host application.

Embodiment 32: The host of the any of the previous 2 embodiments, wherein the initiating receipt of the user data comprises requesting the user data.

Embodiment 33: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 34: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment (UE) in a wireless communication system, the method comprising:
for each resource block (RB) of one or more RBs allocated for a Phase Tracking Reference Signal (PT-RS) port configured for the UE:
determining a PT-RS subcarrier offset for the PT-RS port from a table based on a Demodulation Reference Signal (DMRS) port associated to the PT-RS port, a DMRS configuration type, and a resource element offset parameter configured for the UE, wherein:
the DMRS port associated to the PT-RS port is one of a plurality of DMRS ports, wherein eight of the plurality of DMRS ports are associated to a first DMRS configuration type and twelve of the plurality of DMRS ports are associated to a second DMRS configuration type; and
each row of the table is associated with one of the plurality of DMRS ports and defines different PT-RS subcarrier offsets for a PT-RS port associated to the one of the plurality of DMRS ports for different resource element offset parameter values for at least one of the first DMRS configuration type and the second DMRS configuration type; and
transmitting or receiving a PT-RS on the PT-RS port in the RB in accordance with the determined PT-RS subcarrier offset.

2-40. (canceled)
